(19) United States
(12) Patent Application Publication
(10) Pub. No.: US 2025/0097916 A1
(43) Pub. Date: Mar. 20, 2025

(54) METHOD FOR INDICATING RESOURCE ALLOCATION, METHOD FOR OBTAINING RESOURCE ALLOCATION, COMMUNICATION APPARATUS, AND NAN-TRANSITORY COMPUTER-READABLE STORAGE MEDIUM

(71) Applicant: Beijing Xiaomi Mobile Software Co., Ltd., Beijing (CN)

(72) Inventors: Wensu ZHAO, Beijing (CN); Qun ZHAO, Beijing (CN)

(73) Assignee: Beijing Xiaomi Mobile Software Co., Ltd., Beijing (CN)

(21) Appl. No.: 18/726,893

(22) PCT Filed: Jan. 6, 2022
(86) PCT No.: PCT/CN2022/070567

§ 371 Date: Jul. 5, 2024

(51) Int. Cl. H04W 72/0453; H04W 16/14; H04W 72/40; H04W 72/541

(52) U.S. Cl. CPC H04W 72/0453; H04W 72/40; H04W 72/541; H04W 16/14

(57) ABSTRACT

A method for indicating resource allocation is disclosed. The method is applied to a sidelink-unlicensed frequency band and is performed by a network device. The method includes: determining a frequency domain resource allocation granularity, wherein the frequency domain resource allocation granularity is a sub-channel or an interlaced resource block (IRB); and sending downlink control information to a terminal device based on the frequency domain resource allocation granularity, wherein the downlink control information comprises a frequency domain resource allocation indication domain, and the frequency domain resource allocation indication domain is configured to indicate a frequency domain resource allocated to the terminal device.

### CROSS REFERENCE TO RELATED APPLICATIONS

The present application is a U.S. National Stage of International Application No. PCT/CN2022/070567, filed on Jan. 6, 2022, all contents of which are incorporated herein by reference in their entireties for all purposes.

### TECHNICAL FIELD

The present application relates to the field of communication technologies, and in particular, to a method for indicating resource allocation, a method for obtaining resource allocation, and an apparatus thereof.

### BACKGROUND

At present, as the demand for a plurality of new service and new applications is continuously generated, the sidelink (SL) may have higher and higher requirements for performance such as transmission bandwidth, communication rate, communication delay, reliability, expandability, or the like. If only relying on the limited licensed spectrums of an operator, future potential diversified application scenarios and requirements cannot be satisfied. Therefore, it is needed to research on and design a sidelink technology that can be applied to an unlicensed frequency band (sidelink-unlicensed, SL-U).

### SUMMARY

In a first aspect, according to embodiments of the present application, there is provided a method for indicating resource allocation. The method is applied to a sidelink unlicensed frequency band, and is performed by a network device. The method includes: determining a frequency domain resource allocation granularity, where the frequency domain resource allocation granularity is a sub-channel or an interlaced resource block (IRB); and sending downlink control information to a terminal device based on the frequency domain resource allocation granularity, where the downlink control information includes a frequency domain resource allocation indication domain, and the frequency domain resource allocation indication domain is configured to indicate a frequency domain resource allocated to the terminal device.

In a second aspect, according to embodiments of the present application, there is provided a method for obtaining resource allocation. The method is applied to a sidelink unlicensed frequency band, and is performed by a terminal device. The method includes: determining a frequency domain resource allocation granularity, where the frequency domain resource allocation granularity is a sub-channel or an IRB; and receiving downlink control information sent by a network device based on the frequency domain resource allocation granularity, where the downlink control information includes a frequency domain resource allocation indication domain, and the frequency domain resource allocation indication domain is configured to indicate a frequency domain resource allocated to the terminal device.

In a third aspect, according to embodiments of the present application, there is provided a communication apparatus. The communication apparatus includes a processor and a memory. The memory stores a computer program, and the processor executes the computer program stored in the memory to enable the communication apparatus to perform the method according to the first aspect.

In a fourth aspect, according to embodiments of the present application, there is provided a communication apparatus. The communication apparatus includes a processor and a memory. The memory stores a computer program, and the processor executes the computer program stored in the memory to enable the communication apparatus to perform the method according to the second aspect.

In a fifth aspect, according to embodiments of the present application, there is provided a non-transitory computer-readable storage medium, configured to store an instruction used by a network device. When the instruction is executed, the network device is enabled to perform the method according to the first aspect.

In a thirteenth aspect, according to embodiments of the present application, there is provided a non-transitory computer-readable storage medium, configured to store an instruction used by a terminal device. When the instruction is executed, the terminal device is enabled to perform the method according to the second aspect.

### BRIEF DESCRIPTION OF THE DRAWINGS

To describe the technical solutions in the embodiments of the present application or the background more clearly, the accompanying drawings required in the embodiments of the present application or the background are described below.

FIG. 1 is a schematic architectural diagram of a communication system according to some embodiments of the present application;

FIG. 2 is a flowchart of a method for indicating resource allocation according to some embodiments of the present application;

FIG. 3 is a first structural example diagram of an interlaced resource block (IRB) according to some embodiments of the present application;

FIG. 4 is a second structural example diagram of an interlaced resource block (IRB) according to some embodiments of the present application;

FIG. 5 is an example diagram of a relationship between a resource block set (RB set) and an IRB index according to some embodiments of the present application;

FIG. 6 is a flowchart of another method for indicating resource allocation according to some embodiments of the present application;

FIG. 7 is a flowchart of still another method for indicating resource allocation according to some embodiments of the present application;

FIG. 8 is a first example diagram of a frequency domain resource allocation indication domain according to some embodiments of the present application;

FIG. 9 is a second example diagram of a frequency domain resource allocation indication domain according to some embodiments of the present application;

FIG. 10 is an example diagram of a frequency domain resource allocation indication domain supporting reservation of a resource for one transmission according to some embodiments of the present application;

FIG. 11 is an example diagram of a frequency domain resource allocation indication domain supporting reservation of resources for two transmissions according to some embodiments of the present application;

FIG. 12 is a flowchart of a method for obtaining resource allocation according to some embodiments of the present application;

FIG. 13 is a schematic structural diagram of a communication apparatus according to some embodiments of the present application;

FIG. 14 is a schematic structural diagram of another communication apparatus according to some embodiments of the present application.

### DETAILED DESCRIPTION

Embodiments of the present disclosure are described in detail below, and examples of the embodiments are shown in the accompanying drawings, in which the same or similar reference numerals refer to the same or similar elements or elements with the same or similar functions throughout. The embodiments described below with reference to the accompanying drawings are exemplary and are intended to explain the present disclosure and should not be construed as limitations of the present disclosure. Among them, in the description of the present application, unless otherwise stated, “/” means “or”; for example, A/B may represent A or B; “and/or” here is merely an association relationship describing associated objects, indicating that there may be three relationships; for example, A and/or B may indicate that A exists alone, both A and B exist, and B exists alone.

At present, as the demand for a plurality of new service and new applications is continuously generated, the sidelink (SL) may have higher and higher requirements for performance such as transmission bandwidth, communication rate, communication delay, reliability, expandability, or the like. If only relying on the limited licensed spectrums of an operator, future potential diversified application scenarios and requirements cannot be satisfied. Therefore, it is needed to research on and design a sidelink technology that can be applied to an unlicensed frequency band (sidelink-unlicensed, SL-U).

On an unlicensed frequency band, an OCB (OccupiedChannel Bandwidth, an occupied bandwidth for transmission of a signal on an unlicensed spectrum) requirement needs to be satisfied. That is, each transmission needs to occupy 80% of a bandwidth of a Listen before Talk (LBT) sub-band (for example, 20 MHz). However, currently in SL-U systems, there is a lack of effective means for resource indication.

To this end, the present application provides a method for indicating resource allocation, a method for obtaining resource allocation and an apparatus thereof, which can be applied to an SL-U system. The OCB requirement on an unlicensed frequency band may be satisfied through a resource allocation indication that is based on a sub-channel or an interlaced resource block (IRB) being a frequency domain resource granularity, so that each transmission may occupy 80% of the bandwidth of the LBT sub-band, thus satisfying future potential diversified application scenarios and requirements.

To better understand the method for indicating resource allocation, the method for obtaining resource allocation and the apparatus thereof disclosed in the embodiments of the present application, the communication system used in the embodiments of the present application is described firstly below.

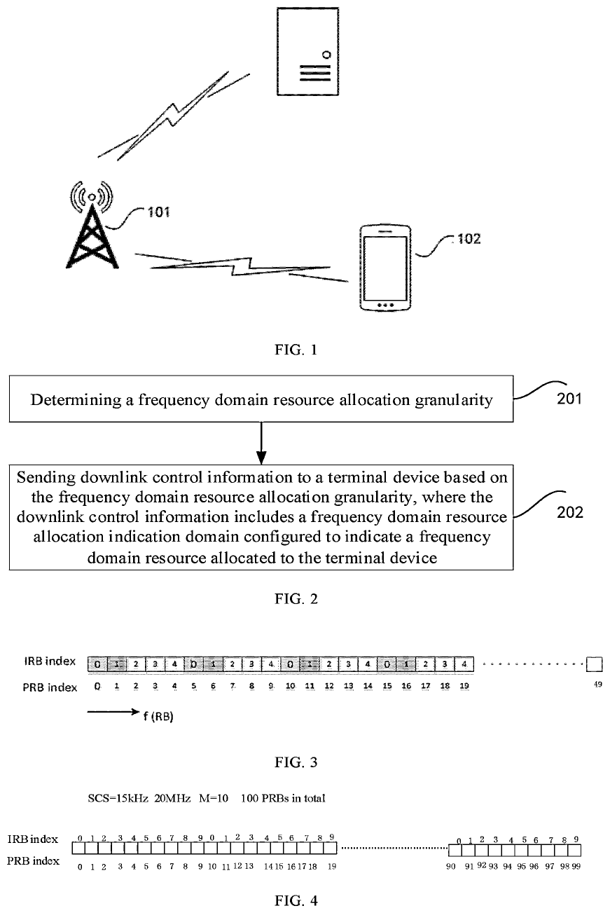

Referring to FIG. 1, FIG. 1 is a schematic architectural diagram of a communication system according to some embodiments of the present application. The communication system may include, but is not limited to, a network device and a terminal device. The quantity and form of devices shown in FIG. 1 are only used for example and do not constitute a limitation on the embodiments of the present application. In the actual application, the communication system may include two or more network devices and two or more terminal devices. In the communication system shown in FIG. 1, it takes that one network device 101 and one terminal device 102 are included as an example.

It should be noted that the technical solutions of the embodiments of the present application may be applied to various communication systems, such as, a long term evolution (LTE) system, a 5th generation (5G) mobile communication system, a 5G new radio (NR) system, an SL-U system, or another future new mobile communication system, etc.

The network device 101 in the embodiments of the present application is an entity on a network side and configured to transmit or receive a signal. For example, the network device 101 may be an evolved NodeB (eNB), a transmission reception point (TRP), a next generation NodeB (gNB) in an NR system, a base station in another future mobile communication system, or an access node in a wireless fidelity (WiFi) system. The specific technology and the specific device form used by the network device are not limited in the embodiments of the present application. The network device provided in the embodiments of the present application may be composed of a central unit (CU) and a distributed unit (DU), where the CU may also be referred to as a control unit. By using a CU-DU structure, protocol layers of a network device, such as a base station, may be split; functions of some protocol layers may be centrally controlled in the CU, and functions of the remaining or all protocol layers are distributed in the DU, and the DU is centrally controlled by the CU.

The terminal device 102 in the embodiments of the present application is an entity on a user side and configured to receive or transmit a signal, such as, a mobile phone. The terminal device may also be referred to as a terminal, user equipment (UE), a mobile station (MS), a mobile terminal (MT), or the like. The terminal device may be a car with a communication function, a smart car, a mobile phone, a wearable device, a tablet computer (Pad), a computer with a wireless transceiving function, a virtual reality (VR) terminal device, an augmented reality (AR) terminal device, a wireless terminal device in industrial control, a wireless terminal device in self-driving, a wireless terminal device in a remote medical surgery, a wireless terminal device in a smart grid, a wireless terminal device in transportation safety, a wireless terminal device in a smart city, a wireless terminal device in a smart home, or the like. The specific technology and the specific device form used by the terminal device are not limited in the embodiments of the present application.

It may be understood that the communication system described in the embodiments of the present application is used to describe the technical solutions of the embodiments of the present application more clearly, and does not constitute a limitation on the technical solutions provided in the embodiments of the present application. Those of ordinary skill in the art may know that, with the evolution of the system architecture and the appearance of the new service scenario, the technical solutions provided in the embodiments of the present application are also applicable to similar technical problems.

The method for indicating resource allocation, the method for obtaining resource allocation and the apparatus thereof provided in the present application are described in detail below with reference to the accompanying drawings.

Referring to FIG. 2, FIG. 2 is a flowchart of a method for indicating resource allocation according to some embodiments of the present application. It should be noted that the method for indicating resource allocation according to the embodiment of the present application is applied on a sidelink unlicensed frequency band, and the method for indicating resource allocation may be performed by a network device. As shown in FIG. 2, the method for indicating resource allocation may include, but is not limited to, the following steps.

In step 201, a frequency domain resource allocation granularity is determined.

Among them, in the embodiments of the present application, the frequency domain resource allocation granularity may be a sub-channel or an interlaced resource block (IRB).

It should be noted that the interlaced resource block (IRB) is introduced into an NR-U system. That is, two continuous available resource blocks are spaced by M resource blocks; and for the IRB index m, the physical resource block (PRB) included in the IRB index m is {m, M+m, 2M+m, 3M+m, . . . }, where m∈{0, 1, . . . M−1}. In an NR-U system, an IRB structure is defined for two sub-carrier spacings (SCS) of 15 kHz and 30 kHz, respectively, as shown in the following table.

TABLE 4.4.4.6-1
Quantity of Interlaced Resource Blocks

| μ | M |
|---|---|
| 0 | 10 |
| 1 | 5 |

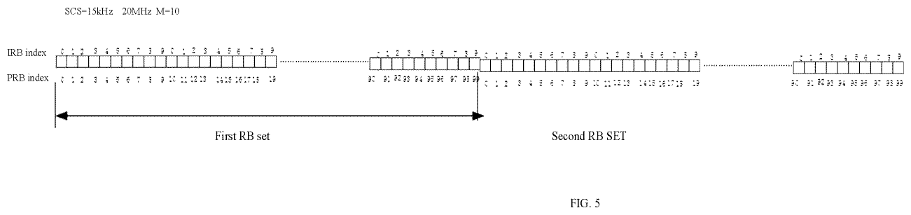

For example, as shown in FIG. 3, when SCS=30 kHz and M=5, there are five interlaced resource block indexes in total. For an IRB index, such as, the IRB index 0, the interlaced resource block index includes an interlaced resource block as PRB {0, 5, 10, 15, 20, 25, 30, 35, 40, 45}. For another example, as shown in FIG. 4, when SCS=15 kHz and M=10, there are 10 interlaced resource block indexes in total, and there are 100 PRBs in total. For an IRB index, such as, the IRB index 0, the interlaced resource block index includes an interlaced resource block as PRB {0, 10, 20, 30, 40, 50, 60, 70, 80, 90}.

It should also be noted that the relationship between the IRB and the resource block set (RB set) is as follows: in NR-U, an LBT sub-band (i.e., 20 MHz) is collectively referred to as a resource block set (RB-set), and the entire carrier bandwidth is divided into a plurality of resource block sets; by configuring a bandwidth part (BWP), the network maps the resource block sets to the BWP; and the protocol specifies that the BWP configured by the network must include an integer number of resource block sets. As shown in FIG. 5, it is a relationship between a resource block set (RB set) and an IRB index, and a resource block set (RB set) includes a plurality of IRB indexes.

In the embodiments of the present application, the network device may determine a frequency domain resource allocation granularity. Among them, the frequency domain resource allocation granularity may be a sub-channel, or may be an interlaced resource block (IRB). For example, the network device may reuse the original frequency domain resource indication manner based on the sub-channel in the downlink control information (DCI) format 3-0, where the design of mapping from the sub-channel to the IRB is added. That is, the network device may reuse the original frequency domain resource indication manner based on the sub-channel in the DCI format 3-0, where the mapping relationship between the sub-channel and the IRB needs to be determined, and the resource indication based on that the sub-channel is the frequency domain resource allocation granularity may be implemented.

It should be noted that at the China Communication Standardization Association (CCSA) conference, it has been agreed that channels such as PSSCHs (Pysical Sidelink Share Channel) and PSFCHs (Physical Sidelink Feedback Channel) in the SL-U system are all based on the IRB structure. Therefore, compared with the resource indication manner based on that the sub-channel is the frequency domain resource allocation granularity in the DCI format 3-0 used for sidelink in the related art, it is necessary to design the DCI for resource indication based on that the IRB is the frequency domain resource allocation granularity. For example, the network device may determine that the IRB is the frequency domain resource allocation granularity, to implement the resource indication based on that the IRB is the frequency domain resource allocation granularity.

In step 202, downlink control information is sent to a terminal device based on the frequency domain resource allocation granularity, where the downlink control information includes a frequency domain resource allocation indication domain, and the frequency domain resource allocation indication domain is configured to indicate a frequency domain resource allocated to the terminal device.

In some embodiments, the bandwidth part (BWP) may be divided according to the size of the BWP and the frequency domain resource allocation granularity to obtain N units. The downlink control information is sent to the terminal device, where the downlink control information may be a DCI format 3-0. The DCI format 3-0 may include a frequency domain resource allocation indication domain, and the frequency domain resource allocation indication domain is used to indicate a unit allocated to the terminal device among the N units.

By implementing the embodiments of the present application, through the resource allocation indication based on that the sub-channel or the interlaced resource block IRB is the frequency domain resource allocation indication granularity, the OCB requirement can be satisfied on the unlicensed frequency band, effectively ensuring the resource utilization rate, thus satisfying the future potential diversified application scenarios and requirements.

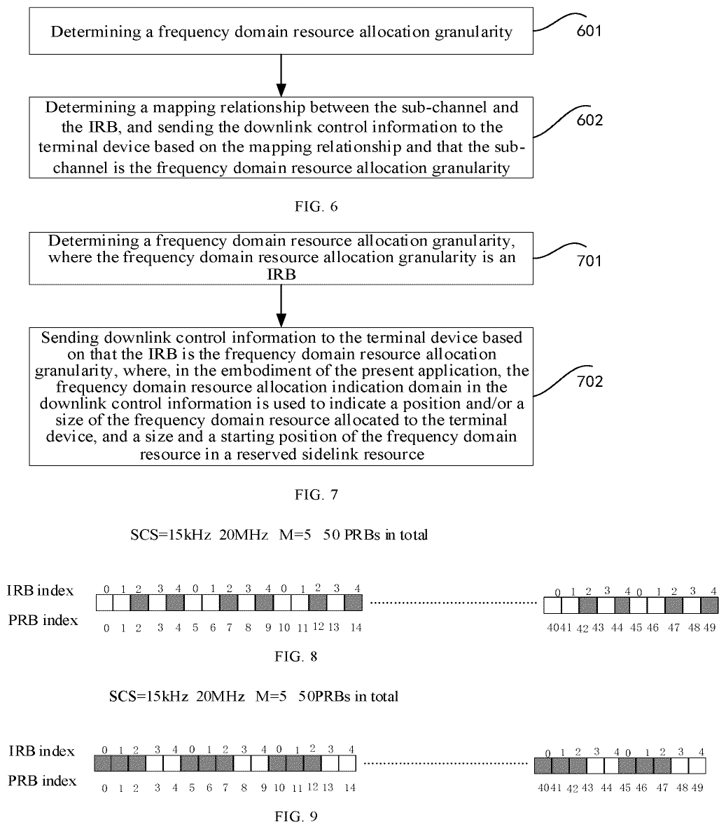

It should be noted that, in the present application, the original frequency domain resource indication manner based on the sub-channel in the DCI format 3-0 may be reused, where the mapping relationship between the sub-channel and the IRB needs to be determined, and the resource indication based on that the sub-channel is the frequency domain resource allocation granularity may be implemented. In some embodiments of the present application, FIG. 6 is a flowchart of another method for indicating resource allocation according to some embodiments of the present application. It should be noted that the method for indicating resource allocation in the embodiment of the present application is applied to a sidelink unlicensed frequency band, and the method for indicating resource allocation may be performed by a network device. As shown in FIG. 6, the method for indicating resource allocation may include, but is not limited to, the following steps.

In step 601, a frequency domain resource allocation granularity is determined. Among them, in the embodiment of the present application, the frequency domain resource allocation granularity may be a sub-channel.

In the embodiment of the present application, the network device may determine that the sub-channel is used as the frequency domain resource allocation granularity.

In step 602, a mapping relationship between the sub-channel and the IRB is determined, and downlink control information is sent to a terminal device based on the mapping relationship and that the sub-channel is the frequency domain resource allocation granularity.

That is, in the present application, the original frequency domain resource indication manner based on the sub-channel in the DCI format 3-0 may be reused, where a mapping relationship between the sub-channel and the IRB needs to be determined.

In some embodiments, the mapping relationship between the sub-channel and the IRB may be determined according to the following manner: determining the mapping relationship between the sub-channel and the IRB as that an IRB index is mapped to a sub-channel, where a quantity of IRB indexes and a quantity of sub-channels included in a given listen-before-talk (LBT) sub-band are the same.

For example, assuming that the quantity of the sub-channels and the quantity of IRB indexes included in a given LBT sub-band (for example, 20 MHz) are the same, it may be determined that the mapping relationship between the sub-channel and the IRB is a one-to-one mapping relationship, that is, one IRB index is mapped to one sub-channel.

In some embodiments, the mapping relationship between the sub-channel and the IRB may be determined according to the following manner: determining the mapping relationship between the sub-channel and the IRB as that each physical resource block (PRB) in a sub-channel is mapped to a specific PRB in an IRB, where a given LBT sub-band includes M sub-channels and N IRBs, M and N are positive integers respectively, and M≠N.

For example, assuming that a given LBT sub-band includes M sub-channels and N IRBs, a one-to-one mapping rule from continuous resource blocks (RBs) in an LBT sub-band to distributed RBs in a sub-band may be established, and each physical resource block (PRB) in a sub-channel may be mapped to a specific PRB in the IRB according to the above mapping rule.

In the embodiment of the present application, after determining the mapping relationship between the sub-channel and the IRB, the downlink control information may be sent to the terminal device based on the mapping relationship and that the sub-channel is used as the frequency domain resource allocation granularity. The downlink control information includes a frequency domain resource allocation indication domain, and the frequency domain resource allocation indication domain is used to indicate a frequency domain resource allocated to the terminal device. In other words, after determining the mapping relationship between IRBs, the network device may continue to use the frequency domain resource indication manner based on the sub-channel.

By implementing the embodiments of the present application, after determining the mapping relationship between the sub-channel and the IRB, the original frequency domain resource indication manner based on the sub-channel in the DCI format 3-0 may be reused, so as to indicate the frequency domain resource allocated to the terminal device, so that the OCB requirement may be satisfied on the unlicensed frequency band. For example, each transmission may occupy 80% of the bandwidth of the LBT sub-band, effectively ensuring the resource utilization rate, thus satisfying future potential diversified application scenarios and requirements.

It should be noted that, in the present application, resource indication may be performed based on that the IRB is the frequency domain resource allocation granularity. In some embodiments of the present application, FIG. 7 is a flowchart of still another method for indicating resource allocation according to some embodiments of the present application. It should be noted that the method for indicating resource allocation in the embodiment of the present application is applied to a sidelink unlicensed frequency band, and the method for indicating resource allocation may be performed by a network device. As shown in FIG. 7, the method for indicating resource allocation may include, but is not limited to, the following steps.

In step 701, a frequency domain resource allocation granularity is determined, where the frequency domain resource allocation granularity is an IRB.

In the embodiment of the present application, the network device may determine that the interlaced resource block (IRB) is used as the frequency domain resource allocation granularity. In other words, in the present application, the frequency domain resource allocation information field in the DCI format 3-0 may be redesigned, and the resource indication may be performed based on that the IRB is the frequency domain resource allocation granularity. In other words, in the embodiments of the present application, the frequency domain resource allocation field in the DCI format 3-0 is used to perform resource indication no longer based on that the sub-channel is the frequency domain resource allocation granularity, but based on that the IRB is the frequency domain resource allocation granularity.

In step 702, downlink control information is sent to the terminal device based on that the IRB is the frequency domain resource allocation granularity. Among them, in the embodiment of the present application, the frequency domain resource allocation indication domain in the downlink control information is used to indicate a position and/or a size of the frequency domain resource allocated to the terminal device, and a size and a starting position of the frequency domain resource in a reserved sidelink resource.

In some embodiments, the bandwidth part (BWP) may be divided according to the size of the BWP and using the IRB as the frequency domain resource allocation granularity, to obtain N units. Downlink control information is sent to the terminal device, where the downlink control information may be a DCI format 3-0. The DCI format 3-0 may include a frequency domain resource allocation indication domain, and the frequency domain resource allocation indication domain is used to indicate a position and/or a size of the frequency domain resource allocated to the terminal device, and a size and a starting position of the frequency domain resource in a reserved sidelink resource.

That is, the sub-channel is a continuous PRB set. It is assumed that a sub-channel includes a quantity N of continuous PRBs, the IRB is a distributed PRB set with equal spaces, and the quantity of resource blocks spaced between two continuous interlaced resource blocks is M. In the embodiments of the present application, the design of Rel−16 NR V2X may be continued to be used, and the frequency domain resource allocation field in the DCI indicates a size (and/or a position) of the frequency domain resource for the current sidelink transmission, as well as a size and a starting position of the frequency domain resource in the reserved sidelink resource.

For example, assuming that the quantity of IRB Indexes included in each LBT sub-band is the same, the frequency domain resource allocation indication domain includes a first part, where the first part may indicate a position and/or a quantity of the IRB indexes in an LBT sub-band on the unlicensed frequency band occupied by the sidelink transmission. It is assumed that the first part includes X bits, and X is a positive integer. In some embodiments, the frequency domain resource allocation indication domain may further include a second part, and the second part may indicate a position and/or a quantity of the LBT sub-band on the unlicensed frequency band (i.e., the resource block set, RB set) occupied by the sidelink transmission. It is assumed that the second part includes Y bits, and Y is a positive integer. In some embodiments, when there is only one LBT sub-band on the unlicensed frequency band, only X bits may be included. For example, when Y=0, it represents that an LBT sub-band (i.e., a resource block set) is allocated.

It should be noted that, since the designs of frequency domain resource allocation and segmentation in the DCI format 3-0 are different, the quantity of bits in the first part and the quantity of bits in the second part may also be different. The implementations of determining the quantity of bits X in the first part and the quantity of bits Y of the second part are provided below, respectively.

In some embodiments, the quantity of bits X in the first part may be determined based on whether the frequency domain resource allocation indication domain indicates the position of the lowest IRB index for the initial transmission and based on the frequency domain resource allocation supporting the frequency domain resource allocation manner that the IRB is the granularity. That is, the quantity of bits X in the first part may be determined according to the following manner: determining the quantity of bits X of the first part based on whether the frequency domain resource allocation indication domain indicates the position of the lowest IRB index for the initial transmission and based on the frequency domain resource allocation manner supported by the frequency domain resource allocation in which the IRB is the granularity, where the lowest IRB index may be understood as the starting IRB index.

In some embodiments, the quantity of bits X of the first part may be L−1, L is a quantity of IRB indexes included in an LBT sub-band, and L is a positive integer, where the frequency domain resource allocation indication domain does not indicate the position of the lowest IRB index for the initial transmission, and the frequency domain resource allocation supports discrete IRB index allocation. As an example, in response to determining that the frequency domain resource allocation indication domain does not indicate the position of the lowest IRB index for the initial transmission, and the frequency domain resource allocation supports discrete IRB index allocation, the quantity of bits X of the first part is determined as L−1, where L is the quantity of IRB indexes included in an LBT sub-band, and L is a positive integer.

For example, assuming that the frequency domain resource allocation field in the DCI format 3-0 does not indicate the position of the lowest (i.e., starting) IRB index for the initial transmission and discrete IRB index allocation is supported, a bitmap may be used for indication. For example, the frequency domain resource allocation field in the DCI format 3-0 does not indicate the position of the lowest IRB index for the initial transmission, but indicates only whether the IRB index higher than the occupied lowest IRB index is occupied or not; for the sending UE, since it is also needed to know the position of the lowest IRB Index for the initial data transmission, an information field is additionally carried in the DCI format 3-0 for indicating the lowest IRB Index for the initial data transmission. In this case, the quantity of bits X of the first part in the DCI format 3-0 is L−1.

As an example, it is assumed that there are 5 IRB indexes {0, 1, 2, 3, 4} in a sub-band of 20 MHz, that is, L=5, and two IRBs of {2, 4} are selected; at this time, the lowest IRB index is 2, and it only indicates whether the IRB index higher than the occupied lowest IRB index 2 is occupied or not; therefore, it is only needed to indicate whether two IRBs with the IRB indexes of 3 and 4 are occupied or not, and only a 2-bit bitmap is needed. If the lowest TRB index is 0, a 4-bit bitmap is needed to indicate whether the remaining IRB indexes are occupied or not. According to the foregoing analysis, assuming that there are totally L IRBs in a sub-band, L−1 bits are needed for indication (if the occupied IRB is not the IRB index 0, there is no need for so many bits; however, the size of the information domain in the DCI should not be dynamically changed, and the maximum value L−1 is taken). Therefore, as shown in FIG. 8, assuming that the SCS=15 KHz, the LBT sub-band is 20 MHz, L=5, and there are 50 PRBs, if two IRBs of {2, 4} are selected, a 4-bit bitmap (where 4 bits correspond to the IRB indexes {1, 2, 3, 4}) is needed, i.e., 0101, which indicates that the IRB indexes 2 and 4 are occupied.

In some embodiments, the downlink control information further includes a lowest IRB index indication domain, and the lowest IRB index indication domain is used to indicate the position of the lowest IRB index for the initial transmission, where the quantity of bits of the lowest IRB index indication domain is log₂(L). That is, the frequency domain resource allocation field in the DCI format 3-0 does not indicate the position of the lowest IRB index for the initial transmission, but only indicates whether the IRB index higher than the occupied lowest IRB index is occupied or not. For a sending UE, since it is also needed to know the position of the lowest IRB index for the initial data transmission, the information field is additionally carried in the DCI format 3-0 for indicating the lowest IRB index for the initial data transmission. For example, the additional information field of the lowest IRB index for the initial transmission (such as, the lowest index of the IRB allocation to initial transmission) additionally carried in the DCI format 3-0 needs log₂(L) bits.

It can be understood that according to the design of R16V2X in the related art, it is needed to inform the sending UE of the lowest IRB index for the initial transmission through the DCI format 3-0, however, the lowest IRB index for the initial transmission is not included in the frequency domain resource allocation information field; therefore, it is needed to add an information field to inform the sending UE of the lowest IRB index. As an example, assuming that a sub-band of 20 MHz have 5 IRB indexes {0, 1, 2, 3, 4}, that is, L=5, a bit length of [log₂(L)] may be used; that is, 3 bits may be used to represent it; if the lowest IRB index for the initial transmission is 1, 001 may be used to represent it.

In another possible implementation, the quantity of bits X of the first part is [log₂(L)], L is a quantity of IRB indexes included in an LBT sub-band, and L is a positive integer, where the frequency domain resource allocation indication domain does not indicate the position of the lowest IRB index for the initial transmission, and the frequency domain resource allocation supports continuous IRB index allocation. As an example, in response to determining that the frequency domain resource allocation indication domain does not indicate the position of the lowest IRB index for the initial transmission and the frequency domain resource allocation supports continuous IRB index allocation, the quantity of bits X of the first part is determined as log₂(L), where L is the quantity of IRB indexes included in an LBT sub-band.

For example, it is assumed that the frequency domain resource allocation field in the DCI format 3-0 does not indicate the position of the lowest (i.e., starting) IRB index for the initial transmission, and only supports continuous IRB index allocation (for example, IRB indexes 2, 3 and 4 are continuously occupied, and occupation of IRB indexes 1 and 4 is not supported). In the DCI format 3-0, the frequency domain resource allocation field does not indicate the position of the lowest IRB Index for the initial transmission, and only indicates the quantity of occupied continuous IRBs; for the sending UE, the position of the lowest IRB index for the initial transmission indicated by the information field still needs to be additionally carried in DCI 3-0. In this case, the quantity of bits X of the first part in the DCI format 3-0 is log₂(L), where the X bits represent the length of the occupied continuous IRBs. For example, assuming that L=5, if the starting IRB index is 0, there are 5 possible lengths of 1, 2, 3, 4, and 5; if the starting IRB index is 3, there are 2 possible lengths of 1 (for example, only IRB index 3 is occupied) and 2 (for example, IRB index 3 and 4 are occupied); and therefore, there is at most L possibilities.

As an example, as shown in FIG. 9, assuming that the SCS=15 KHz, the LBT sub-band is 20 MHz, L=5, and there are 50 PRBs, if the IRB index is 0, and the continuous occupancy length is 1 (that is, IRB index 0 is occupied), 001 is used to represent it; if the continuous occupancy length is 2 (that is, IRB indexes 0 and 1 are occupied), 010 is used to represent it; and if the continuous occupancy length is 3 (that is, IRB indexes 0, 1, and 2 are occupied), 011 is used to represent it.

In some embodiments, the downlink control information further includes a lowest IRB index indication domain, and the lowest IRB index indication domain is used to indicate the position of the lowest IRB index for the initial transmission, where the quantity of bits of the lowest IRB index indication domain is log₂(L). That is, the frequency domain resource allocation field in the DCI format 3-0 does not indicate the position of the lowest IRB index for the initial transmission, but only indicates whether the IRB index higher than the occupied lowest IRB index is occupied or not. For a sending UE, since it is also needed to know the position of the lowest IRB index for the initial data transmission, the information field is additionally carried in the DCI format 3-0 for indicating the lowest IRB index for the initial data transmission. For example, the additional information field of the lowest IRB index for the initial transmission (such as, the lowest index of the IRB allocation to initial transmission) additionally carried in the DCI format 3-0 needs log₂(L) bits.

It can be understood that according to the design of R16 V2X in the related art, it is needed to inform the sending UE of the lowest IRB index for the initial transmission through the DCI format 3-0, however, the lowest IRB index for the initial transmission is not included in the frequency domain resource allocation information field; therefore, it is needed to add an information field to inform the sending UE of the lowest IRB index. As an example, assuming that a sub-band of 20 MHz have 5 IRB indexes {0, 1, 2, 3, 4}, that is, L=5, a bit length of [log₂(L)] may be used; that is, 3 bits may be used to represent it; if the lowest IRB index for the initial transmission is 1, 001 may be used to represent it.

It should be noted that, in the frequency domain resource allocation information field in the DCI format 3-0, the position of the lowest IRB index for the initial transmission may be indicated. Therefore, there is no need to design an additional information field in the DCI format 3-0 to inform the sending UE of the lowest IRB index for the initial transmission. According to whether the discrete IRB index allocation is supported or not, there may be the following two methods.

In some embodiments, the quantity of bits X of the first part may be L, L is a quantity of IRB indexes included in an LBT sub-band, and L is a positive integer, where the frequency domain resource allocation indication domain indicates the position of the lowest IRB index for the initial transmission, and the frequency domain resource allocation supports discrete IRB index allocation. As an example, in response to determining that the frequency domain resource allocation indication domain indicates the position of the lowest IRB index for the initial transmission, and the frequency domain resource allocation supports discrete IRB index allocation, the quantity X of bits of the first part is determined as L, where L is the quantity of IRB indexes included in an LBT sub-band (i.e., a resource block set, RB set), L is an integer, and L≥0.

For example, in the frequency domain resource allocation field in the DCI format 3-0, the position of the lowest IRB index for the initial transmission may be indicated and discrete IRB index allocation is supported, a bitmap may be used for indication. At this time, X=L bits, which indicates the position of the starting IRB index and the quantity of occupied IRBs.

In some embodiments, the quantity of bits X of the first part is

$$[ {log}_{2} ( \frac{L ( L + 1 )}{2} ) ] ,$$

L is a quantity of IRB indexes included in an LBT sub-band, and L is a positive integer, where the frequency domain resource allocation indication domain indicates the position of the lowest IRB index for the initial transmission, and the frequency domain resource allocation supports continuous IRB index allocation. As an example, in response to determining that the frequency domain resource allocation indication domain indicates the position of the lowest IRB index for the initial transmission, and the frequency domain resource allocation supports continuous IRB index allocation, the quantity of bits X of the first part is determined as

$$[ {log}_{2} ( \frac{L ( L + 1 )}{2} ) ] ,$$

where L is the quantity of TRB indexes included in an LBT sub-band.

For example, assuming that in the frequency domain resource allocation information field in the DCI format 3-0, the position of the lowest IRB Index for the initial transmission may be indicated, and continuous IRB Index allocation is supported, at this time,

$$X = [ {log}_{2} ( \frac{L ( L + 1 )}{2} ) ] ,$$

which indicates the starting position of the IRB Index and the quantity of occupied continuous IRBs.

It may be understood that a manner for determining the quantity of bits X of the first part in the DCI is provided above, and a manner for determining the quantity of bits Y of the second part in the DCI is provided below.

In the embodiments of the present application, the design idea of R16 NR-U may be continued to be used, and only resource allocation of continuous RB sets is supported. In addition, according to whether supporting the same distribution rule of IRB indexes in different RB sets or not, there may be the following cases.

In some embodiments, the quantity of bits Y of the second part is

$$[ {log}_{2} ( \frac{K ( K + 1 )}{2} ) ] ,$$

K is the quantity of resource block sets included in the sidelink bandwidth part (BWP), and K is a positive integer, where the frequency domain resource allocation supports resource allocation of continuous resource block sets, and supports the same distribution rule of the TRB indexes in different resource block sets, and supports reservation of a resource for one transmission. As an example, in response to the frequency domain resource allocation supporting resource allocation of continuous resource block sets, supporting the same distribution rule of the IRB indexes in different resource block sets, and supporting reservation of a resource for one transmission, the quantity of bits Y of the second part is determined as

$$[ {log}_{2} ( \frac{K ( K + 1 )}{2} ) ] ,$$

where K is the quantity of resource block sets included in the sidelink bandwidth part (BWP).

For example, assuming that the frequency domain resource allocation supports resource allocation of continuous resource block sets, supports the same distribution rule of IRB indexes in different resource block sets, and supports reservation of a resource for one transmission (i.e., the frequency domain resource allocation field in DCI may not only indicate the frequency domain resource used for the initial transmission, but also indicate the resource reserved for future transmission, for example, may indicate the resource reserved for one transmission), the quantity of bits Y of the second part in the DCI may be determined as

$$[ {log}_{2} ( \frac{K ( K + 1 )}{2} ) ] ,$$

which indicates a quantity of the starting RB set and the continuous RB sets of the resource reserved for one transmission.

In some embodiments, the quantity of bits Y of the second part is

$$[ {log}_{2} ( \frac{K ( K + 1 ) ( 2 K + 1 )}{6} ) ] ,$$

K is the quantity of resource block sets included in the sidelink bandwidth part (BWP), and K is a positive integer, where the frequency domain resource allocation supports resource allocation of continuous resource block sets, and supports the same distribution rule of the IRB indexes in different resource block sets, and supports reservation of resources for two transmissions. As an example, in response to the frequency domain resource allocation supporting resource allocation of continuous resource block sets, and supporting the same distribution rule of the IRB indexes in different resource block sets, and supporting reservation of resources for two transmissions, the quantity of bits Y of the second part is determined as

$$[ {log}_{2} ( \frac{K ( K + 1 ) ( 2 K + 1 )}{6} ) ] ,$$

where K is the quantity of resource block sets included in the sidelink bandwidth part (BWP).

For example, assuming that the frequency domain resource allocation supports resource allocation of continuous resource block sets, and supports the same distribution rule of the IRB indexes in different resource block sets, and supports reservation of resources for two transmissions (i.e., the frequency domain resource allocation field in DCI may not only indicate the frequency domain resources used for the initial transmission, but also indicate the resource reserved for future transmission, for example, may indicate the resource reserved for two transmissions), the quantity of bits Y of the second part in the DCI may be determined as

$$[ {log}_{2} ( \frac{K ( K + 1 ) ( 2 K + 1 )}{6} ) ] ,$$

which indicates a quantity of the starting RB set of the resource reserved for two transmissions and the continuous RB sets of the resource reserved for one transmission (where the quantity of continuous RB sets in the resources reserved for two transmissions is the same), where K represents the quantity of resource block sets (RB set) included in the sidelink bandwidth part (BWP).

For example, assuming that the BWP includes K RB sets, and K=5, when reservation of a resource for one transmission is supported, Y=4 bits; when Y for resource allocation is 0100, it indicates that when the starting RB set of the allocated resource reserved for one transmission is the first RB set, the quantity of continuous RB sets is 4, and the distribution rules of the IRB indexes in different RB sets are the same. For example, if the TRB index in the first RB set is allocated with IRB index {0, 1, 2}, the IRB indexes in the RB sets 2, 3, and 4 are also allocated with {0, 1, 2}.

In some embodiments, the quantity of bits Y of the second part is

$$[ {log}_{2} ( \frac{K ( K + 1 )}{2} ) ] ,$$

K is the quantity of resource block sets included in the sidelink bandwidth part (BWP), and K is a positive integer, where the frequency domain resource allocation supports resource allocation of continuous resource block sets, and supports different distribution rules of IRB indexes in different resource block sets, and supports reservation of a resource for one transmission. As an example, in response to the frequency domain resource allocation supporting resource allocation of continuous resource block sets and supporting different distribution rules of IRB indexes in different resource block sets, and supporting reservation of a resource for one transmission, the quantity of bits Y of the second part is determined as

$$[ {log}_{2} ( \frac{K ( K + 1 )}{2} ) ] ,$$

where K is the quantity of resource block sets included in the sidelink bandwidth part (BWP).

For example, assuming that the frequency domain resource allocation supports resource allocation of continuous resource block sets, and supports different distribution rules of IRB indexes in different resource block sets, and supports reservation of a resource for one transmission, the quantity of bits Y of the second part may be determined as

$$[ {log}_{2} ( \frac{K ( K + 1 )}{2} ) ] ,$$

which indicates a quantity of the starting RB set and the continuous RB sets of the resource reserved for one transmission.

In some embodiments, the quantity of bits Y of the second part is

$$[ {log}_{2} ( \frac{K ( K + 1 ) ( 2 K + 1 )}{6} ) ] ,$$

K is the quantity of resource block sets included in the sidelink bandwidth part (BWP), and K is a positive integer, where the frequency domain resource allocation supports resource allocation of continuous resource block sets, and supports different distribution rules of the IRB indexes in different resource block sets, and supports reservation of resources for two transmissions. As an example, in response to the frequency domain resource allocation supporting resource allocation of continuous resource block sets and supporting different distribution rules of IRB indexes in different resource block sets, and supporting reservation of resources for two transmissions, the quantity of bits Y of the second part is determined as

$$[ {log}_{2} ( \frac{K ( K + 1 ) ( 2 K + 1 )}{6} ) ] ,$$

where K is the quantity of resource block sets included in the sidelink bandwidth part (BWP).

For example, assuming that the frequency domain resource allocation supports resource allocation of continuous resource block sets, and supports different distribution rules of the IRB indexes in different resource block sets, and supports reservation of resources for two transmissions, the quantity of bits Y of the second part may be determined as

$$[ {log}_{2} ( \frac{K ( K + 1 ) ( 2 K + 1 )}{6} ) ] ,$$

which indicates a quantity of the starting RB set of the resource reserved for two transmissions and the continuous RB sets of the resource reserved for one transmission.

In some embodiments, the downlink control information further includes a first offset indication domain, and the first offset indication domain is used to indicate an offset of the TRB index in adjacent resource block sets in the resource for current transmission, or indicate an offset of the IRB index in adjacent resource block sets in the resource reserved for one transmission, or indicate an offset of the IRB index in adjacent resource block sets in the resource reserved for another transmission, where the quantity of bits of the first offset indication domain is [log₂ (L)], and L is the quantity of IRB indexes included in an LBT sub-band.

In other words, a new information field of IRB index offset S bit is introduced into the DCI, and the information field indicates the offset of the IRB Index in adjacent RB sets in the resource for current transmission or in the resource reserved for one transmission or in the resource reserved for another transmission. Under this offset, the IRB Index is cyclic, and the quantity of bits of the offset S is log₂(L).

As an example, it is assumed that in the resource for current transmission, three RB sets are allocated; in the first RB set, the distribution of the IRB index is {1, 2}; if the offset of the IRB index in the second RB set is one IRB index, the distribution is {3, 4}; and if the offset of the IRB index in the third RB set relative to the IRB index in the second RB set is also one IRB index, the distribution is {4, 0}. Similarly, for the resource reserved for one transmission, three RB sets are allocated; among the three RB sets, in the first RB set, the distribution of the IRB index is {2, 3}; if the offset of the IRB index in the second RB set is one IRB index, the distribution is {4, 04}; and if the offset of the IRB index in the third RB set relative to the TRB index in the second RB set is also one IRB index, the distribution is {0, 1}. Among them, there are five possible offsets {0, 1, 2, 3, 4}; that is, there are L possibilities. Therefore, [log₂(L)] bits are used to represent it.

It should be noted that the present application may not continue to use the design idea of R16 NR-U, and may support resource allocation of discrete RB sets. According to whether supporting the same distribution rule of IRB indexes in different RB sets or not, there may be the following cases.

In some embodiments, the quantity of bits Y of the second part is K−1+K, where K is the quantity of resource block sets included in the sidelink bandwidth part (BWP), and K is a positive integer. Among them, the frequency domain resource allocation supports resource allocation of discrete resource block sets, and supports the same distribution rule of the IRB indexes in different resource block sets, and supports reservation of a resource for one transmission. As an example, in response to the frequency domain resource allocation supporting resource allocation of discrete resource block sets and supporting the same distribution rule of the IRB indexes in different resource block sets, and supporting reservation of a resource for one transmission, the quantity of bits Y of the second part is determined as K−1+K, where K is the quantity of resource block sets included in the sidelink bandwidth part (BWP).

For example, a bitmap may be used for indication, where each bit represents whether the RB set is occupied or not. Assuming that the frequency domain resource allocation supports resource allocation of discrete resource block sets, supports the same distribution rule of the IRB indexes in different resource block sets, and supports reservation of a resource for one transmission in SCI (Sidelink Control Information), the quantity of bits Y of the second part may be determined as K−1+K, which indicates the RB set occupied by the current transmission (but only indicates whether the RB set higher than the occupied RB set is occupied or not, thus K−1 bits are needed), and meanwhile indicates the starting position of the resource reserved for one transmission and the occupied RB sets, which needs L bits.

In some embodiments, the quantity of bits Y of the second part is 3K−1, where K is the quantity of resource block sets included in the sidelink bandwidth part (BWP), and K is a positive integer. Among them, the frequency domain resource allocation supports resource allocation of discrete resource block sets, and supports the same distribution rule of the TRB indexes in different resource block sets, and supports reservation of resources for two transmissions. As an example, in response to the frequency domain resource allocation supporting resource allocation of discrete resource block sets and supporting the same distribution rule of the IRB indexes in different resource block sets, and supporting reservation of resources for two transmissions, the quantity of bits Y of the second part is determined as 3K−1 where K is the quantity of resource block sets included in the sidelink bandwidth part (BWP).

For example, a bitmap may be used for indication, where each bit represents whether the RB set is occupied or not. Assuming that the frequency domain resource allocation supports resource allocation of discrete resource block sets and supports the same distribution rule of the TRB indexes in different resource block sets, and supports reservation of resources for two transmissions, the quantity of bits Y of the second part may be determined as 3K−1, which indicates the RB set occupied by the current transmission, but only indicates whether the RB set higher than the occupied RB set is occupied or not (which needs K−1 bits), meanwhile indicates the starting position of the resource reserved for one transmission and the quantity of the occupied RB sets (which needs K bits), as well as the starting position of the resource reserved for another transmission and the quantity of the occupied RB sets (which needs K bits).

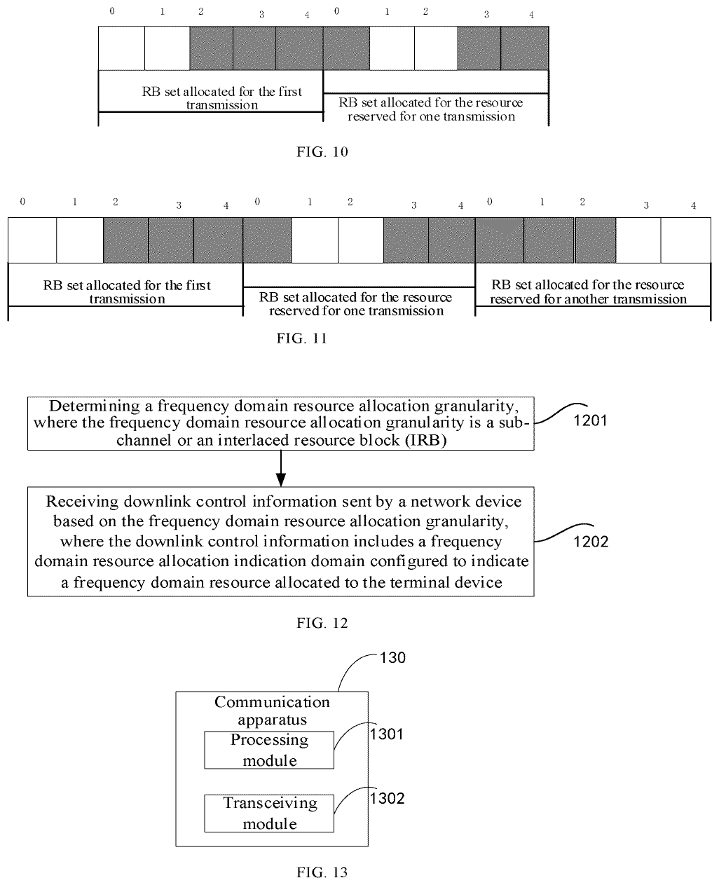

As an example, a bitmap may be used for indication, where each bit represents whether the RB set is occupied or not. It is assumed that the frequency domain resource allocation supports resource allocation of discrete resource block sets, and supports the same distribution rule of the IRB indexes in different resource block. For example, reservation of a resource for one transmission in SCI is supported, Y=K−1+K bits; and assuming K=5, Y=9 bits. As shown in FIG. 10, for the bits of 0011 10001, the first 4 bits of 0011 indicate the RB sets occupied by current transmission, and the RB sets with the indexes of 2, 3, and 4 are occupied (since 0011 indicates whether an RB set with a corresponding index of 1, 2, 3, or 4 is occupied or not, and it represents that the indexes of 3 and 4 are occupied and indicates whether the RB set higher than the occupied RB set is occupied or not, it indicates that the RB set with the index of 2 is also occupied), and the last 5 bits of 10001 indicates the RB sets occupied by the resource reserved for one transmission by using a bitmap. For another example, reservation of resources for two transmissions in SCI is supported; as shown in FIG. 11, Y=3K−1 bits are used; that is, 14 bits (such as, 0011 10001 11100) is used for indication.

In some embodiments, the quantity of bits Y of the second part is K−1+K, where K is a quantity of resource block sets included in the sidelink bandwidth part (BWP), and K is a positive integer, where the frequency domain resource allocation supports resource allocation of discrete resource block sets, and supports different distribution rules of IRB indexes in different resource block sets, and supports reservation of a resource for one transmission. As an example, in response to the frequency domain resource allocation supporting resource allocation of discrete resource block sets and supporting different distribution rules of TRB indexes in different resource block sets, and supporting reservation of a resource for one transmission, the quantity of bits Y of the second part is determined as K−1+K, where K is the quantity of resource block sets included in the sidelink bandwidth part (BWP).

For example, the bitmap may be used for indication. If different distribution rules of IRB indexes in different resource block sets is supported, and reservation of a resource for one transmission in SCI is supported, the quantity of bits of the second part may be determined as Y=K−1+K.

In some embodiments, the quantity of bits Y of the second part is 3K−1, where K is the quantity of resource block sets included in the sidelink bandwidth part (BWP), and K is a positive integer. Among them, the frequency domain resource allocation supports resource allocation of discrete resource block sets, and supports different distribution rules of TRB indexes in different resource block sets, and supports reservation of resources for two transmissions. As an example, in response to the frequency domain resource allocation supporting resource allocation of discrete resource block sets and supporting different distribution rules of IRB indexes in different resource block sets, and supporting reservation of resources for two transmissions, the quantity of bits Y of the second part is determined as 3K−1, where K is the quantity of resource block sets included in the sidelink bandwidth part (BWP).

For example, the bitmap may be used for indication. If different distribution rules of IRB indexes in different resource block sets is supported, and reservation of resources for two transmissions in SCI is supported, the quantity of bits of the second part may be determined as Y=3K−1.

In some embodiments, the downlink control information further includes a second offset indication domain, and the second offset indication domain is used to indicate an offset of IRB indexes in adjacent resource block sets in the resource for the current transmission, or indicate an offset of IRB indexes in adjacent resource block sets in the resource reserved for one transmission, or indicate an offset of IRB indexes in adjacent resource block sets in the resource reserved for another transmission, where the quantity of bits of the second offset indication domain is log₂(L), and L is the quantity of IRB indexes included in an LBT sub-band.

As an example, the bitmap may be used for indication. If different distribution rules of the IRB index in different RB sets is supported, and reservation of a resource for one transmission in SCI is supported, the quantity of bits may be determined as Y=N−1+N. If reservation of resources for two transmissions in SCI is supported, the quantity of bits may be determined as Y=3N−1. However, an information field offset is introduced into the DCI, the information field indicates the offset of the IRB index in adjacent RB sets in the resource for the current transmission or in the resource reserved for one transmission or in the resource reserved for another transmission, and the quantity of bits of the offset may be log₂(L).

In conclusion, in the embodiments of the present application, the resource indication is performed based on that the IRB is the minimum frequency domain allocation granularity for PSSCH in the SL-U system, where the frequency domain resource allocation information field in the DCI format 3-0 is redefined, the design of an offset of the IRB index and the design of the lowest IRB index for the initial transmission are introduced. Therefore, the OCB requirement may be satisfied on the unlicensed frequency band based on the resource allocation indication in which the IRB is the frequency domain resource allocation granularity, so that each transmission may occupy 80% of the bandwidth of the LBT sub-band, effectively ensuring the resource utilization rate, thus satisfying future potential diversified application scenarios and requirements.

In some embodiments of the present application, on the basis of any one of the foregoing embodiments, the network device may further send configuration information to the terminal device, where different values of the configuration information are used to indicate enabling or disabling sending the downlink control information to the terminal device based on that the IRB is the frequency domain resource allocation granularity.

For example, (preset) configuration information may be added, and the terminal device may obtain the configuration information by receiving downlink control signaling (DCI) or radio resource control (RRC) from the base station, or through pre-configuration. In some embodiments, the configuration information may be configured based on a resource pool, or may be configured based on the UE, or may be configured based on a BWP, or may be configured based on a carrier.

In some embodiments, different values of the configuration information represent enabling or disabling the resource allocation manner in which the IRB is the frequency domain resource allocation granularity.

By implementing the embodiments of the present application, the OCB requirement may be satisfied on the unlicensed frequency band through the resource allocation indication based on that the interlaced resource block (IRB) is the frequency domain resource allocation granularity, so that each transmission may occupy 80% of the bandwidth of the LBT sub-band, effectively ensuring the resource utilization rate, thus satisfying future potential diversified application scenarios and requirements.

It may be understood that, in the foregoing embodiments, the implementation of the method for indicating resource allocation in the embodiments of the present application is described from the network device side. According to embodiments of the present application, there is further provided a method for obtaining resource allocation. The implementation of the method for obtaining resource allocation is described below from the terminal device side. Referring to FIG. 12, FIG. 12 is a flowchart of a method for obtaining resource allocation according to some embodiments of the present application. It should be noted that the method for obtaining resource allocation in the embodiments of the present application is applied to a sidelink unlicensed frequency band, and may be performed by the terminal device. As shown in FIG. 12, the method for obtaining resource allocation may include, but is not limited to, the following steps.

In step 1201, a frequency domain resource allocation granularity is determined, where the frequency domain resource allocation granularity may be a sub-channel or an interlaced resource block (IRB).

In the embodiments of the present application, step 1201 may be implemented by using any one of the embodiments of the present application, which is not limited in the embodiment of the present application, and is not described in detail here again.

In step 1202, downlink control information sent by a network device based on the frequency domain resource allocation granularity is received, where the downlink control information includes a frequency domain resource allocation indication domain, and the frequency domain resource allocation indication domain is configured to indicate a frequency domain resource allocated to the terminal device.

In some embodiments, the network device may divide the bandwidth part (BWP) according to the size of the BWP and the frequency domain resource allocation granularity, to obtain N units, and send the downlink control information to the terminal device. The terminal device may receive the downlink control information sent by the network device based on the frequency domain resource allocation granularity. Among them, the downlink control information may be a DCI format 3-0. The DCI format 3-0 may include a frequency domain resource allocation indication domain, and the frequency domain resource allocation indication domain is used to indicate a unit allocated to the terminal device among the N units.

It should be noted that, in the present application, the original frequency domain resource indication manner based on the sub-channel in the DCI format 3-0 may be reused, where the mapping relationship between the sub-channel and the IRB needs to be determined, and the resource indication based on that the sub-channel is the frequency domain resource allocation granularity may be implemented. In some embodiments of the present application, assuming that the frequency domain resource allocation granularity is the sub-channel, the terminal device may determine a mapping relationship between the sub-channel and the IRB, and receive downlink control information sent by the network device based on the mapping relationship and that the sub-channel is the frequency domain resource allocation granularity.

That is, in the present application, the original frequency domain resource indication manner based on the sub-channel in the DCI format 3-0 may be reused, where a mapping relationship between the sub-channel and the IRB needs to be determined.

In some embodiments, the mapping relationship between the sub-channel and the IRB may be determined according to the following manner: determining the mapping relationship between the sub-channel and the IRB as that an IRB index is mapped to a sub-channel, where a quantity of IRB indexes and a quantity of sub-channels included in a given listen-before-talk (LBT) sub-band are the same.

For example, assuming that the quantity of the sub-channels and the quantity of IRB indexes included in a given LBT sub-band (for example, 20 MHz) are the same, it may be determined that the mapping relationship between the sub-channel and the TRB is a one-to-one mapping relationship, that is, one IRB index is mapped to one sub-channel.

In some embodiments, the mapping relationship between the sub-channel and the IRB may be determined according to the following manner: determining the mapping relationship between the sub-channel and the IRB as that each physical resource block (PRB) in a sub-channel is mapped to a specific PRB in an IRB, where a given LBT sub-band includes M sub-channels and N IRBs, M and N are positive integers respectively, and M≠N.

For example, assuming that a given LBT sub-band includes M sub-channels and N IRBs, a one-to-one mapping rule from continuous resource blocks (RBs) in an LBT sub-band to distributed RBs in a sub-band may be established, and each physical resource block (PRB) in a sub-channel may be mapped to a specific PRB in the IRB according to the above mapping rule.

In the embodiment of the present application, after determining the mapping relationship between the sub-channel and the IRB, the network device may send the downlink control information to the terminal device based on the mapping relationship and that the sub-channel is used as the frequency domain resource allocation granularity. The terminal device may determine a mapping relationship between a sub-channel and an IRB, and receive downlink control information sent by the network device based on the mapping relationship and that the sub-channel is the frequency domain resource allocation granularity, where the downlink control information includes a frequency domain resource allocation indication domain, and the frequency domain resource allocation indication domain is used to indicate a frequency domain resource allocated to the terminal device. In other words, after determining the mapping relationship between IRBs, the network device and the terminal device may continue to use the frequency domain resource indication manner based on the sub-channel.

It should be noted that in the present application, resource indication may be performed based on that the IRB is the frequency domain resource allocation granularity. In other words, in the present application, the frequency domain resource allocation information field in the DCI format 3-0 may be redesigned, and the resource indication may be performed based on that the IRB is the frequency domain resource allocation granularity. In other words, in the embodiments of the present application, the frequency domain resource allocation field in the DCI format 3-0 is used to perform resource indication no longer based on that the sub-channel is the frequency domain resource allocation granularity, but based on that the IRB is the frequency domain resource allocation granularity.

In some embodiments, the network device may divide the bandwidth part (BWP) according to the size of the BWP and using the IRB as the frequency domain resource allocation granularity to obtain N units, and send downlink control information to the terminal device. The terminal device may receive the downlink control information sent by the network device based on that the IRB is the frequency domain resource allocation granularity, where the downlink control information may be a DCI format 3-0. The DCI format 3-0 may include a frequency domain resource allocation indication domain, and the frequency domain resource allocation indication domain is used to indicate a position and/or a size of the frequency domain resource allocated to the terminal device, and a size and a starting position of the frequency domain resource in a reserved sidelink resource.

That is, the sub-channel is a continuous PRB set. It is assumed that a sub-channel includes a quantity N of continuous PRBs, the TRB is a distributed PRB set with equal spaces, and the quantity of resource blocks spaced between two continuous interlaced resource blocks is M. In the embodiments of the present application, the design of Rel−16 NR V2X may be continued to be used, and the frequency domain resource allocation field in the DCI indicates a size (and/or a position) of the frequency domain resource for the current sidelink transmission, as well as a size and a starting position of the frequency domain resource in the reserved sidelink resource.

For example, assuming that the quantity of IRB Indexes included in each LBT sub-band is the same, the frequency domain resource allocation indication domain includes a first part, where the first part may indicate a position and/or a quantity of the IRB indexes in an LBT sub-band on the unlicensed frequency band occupied by the sidelink transmission. It is assumed that the first part includes X bits, and X is a positive integer. In some embodiments, the frequency domain resource allocation indication domain may further include a second part, and the second part may indicate a position and/or a quantity of the LBT sub-band on the unlicensed frequency band (i.e., the resource block set, RB set) occupied by the sidelink transmission. It is assumed that the second part includes Y bits, and Y is a positive integer. In some embodiments, when there is only one LBT sub-band on the unlicensed frequency band, only X bits may be included. For example, when Y=0, it represents that an LBT sub-band (i.e., a resource block set) is allocated.

It should be noted that, since the designs of frequency domain resource allocation and segmentation in the DCI format 3-0 are different, the quantity of bits in the first part and the quantity of bits in the second part may also be different. The implementations of determining the quantity of bits X in the first part and the quantity of bits Y of the second part are provided below, respectively.

In some embodiments, X may be determined based on whether the frequency domain resource allocation indication domain indicates the position of the lowest IRB index for the initial transmission and based on the frequency domain resource allocation manner supported by the frequency domain resource allocation in which the IRB is the granularity. That is, the quantity of bits X of the first part may be determined according to the following manner: determining the quantity of bits X of the first part based on whether the frequency domain resource allocation indication domain indicates the position of the lowest IRB index for the initial transmission and based on the frequency domain resource allocation manner supported by the frequency domain resource allocation in which the IRB is the granularity, where the lowest IRB index may be understood as the starting IRB index.

In some embodiments, X is L−1, L is a quantity of TRB indexes included in an LBT sub-band, and L is a positive integer, where the frequency domain resource allocation indication domain does not indicate the position of the lowest IRB index for the initial transmission, and the frequency domain resource allocation supports discrete IRB index allocation. As an example, in response to determining that the frequency domain resource allocation indication domain does not indicate the position of the lowest IRB index for the initial transmission, and the frequency domain resource allocation supports discrete IRB index allocation, the quantity of bits X of the first part is determined as L−1, where L is the quantity of IRB indexes included in an LBT sub-band, L is a positive integer, and L≥0.

For example, assuming that the frequency domain resource allocation field in the DCI format 3-0 does not indicate the position of the lowest (i.e., starting) IRB index for the initial transmission and discrete IRB index allocation is supported, a bitmap may be used for indication. For example, the frequency domain resource allocation field in the DCI format 3-0 does not indicate the position of the lowest IRB index for the initial transmission, but indicates only whether the IRB index higher than the occupied lowest IRB index is occupied or not; for the sending UE, since it is also needed to know the position of the lowest IRB Index for the initial data transmission, an information field is additionally carried in the DCI format 3-0 for indicating the lowest IRB Index for the initial data transmission. In this case, the quantity of bits X of the first part in the DCI format 3-0 is L−1.

As an example, it is assumed that there are 5 IRB indexes {0, 1, 2, 3, 4} in a sub-band of 20 MHz, that is, L=5, and two IRBs of {2, 4} are selected; at this time, the lowest IRB index is 2, and it only indicates whether the IRB index higher than the occupied lowest IRB index 2 is occupied or not; therefore, it is only needed to indicate whether two IRBs with the IRB indexes of 3 and 4 are occupied or not, and only a 2-bit bitmap is needed. If the lowest IRB index is 0, a 4-bit bitmap is needed to indicate whether the remaining IRB indexes are occupied or not. According to the foregoing analysis, assuming that there are totally L IRBs in a sub-band, L−1 bits are needed for indication (if the occupied IRB is not the IRB index 0, there is no need for so many bits; however, the size of the information domain in the DCI should not be dynamically changed, and the maximum value L−1 is taken). Therefore, as shown in FIG. 8, assuming that the SCS=15 KHz, the LBT sub-band is 20 MHz, L=5, and there are 50 PRBs, if two IRBs of {2, 4} are selected, a 4-bit bitmap (where 4 bits correspond to the IRB indexes {1, 2, 3, 4}) is needed, i.e., 0101, which indicates that the IRB indexes 2 and 4 are occupied.

In some embodiments, the downlink control information further includes a lowest IRB index indication domain, and the lowest IRB index indication domain is used to indicate the position of the lowest IRB index for the initial transmission, where the quantity of bits of the lowest IRB index indication domain is log₂(L). That is, the frequency domain resource allocation field in the DCI format 3-0 does not indicate the position of the lowest IRB index for the initial transmission, but only indicates whether the IRB index higher than the occupied lowest IRB index is occupied or not. For a sending UE, since it is also needed to know the position of the lowest IRB index for the initial data transmission, the information field is additionally carried in the DCI format 3-0 for indicating the lowest IRB index for the initial data transmission. For example, the additional information field of the lowest IRB index for the initial transmission (such as, the lowest index of the IRB allocation to initial transmission) additionally carried in the DCI format 3-0 needs log₂(L) bits.

It can be understood that according to the design of R16 V2X in the related art, it is needed to inform the sending UE of the lowest IRB index for the initial transmission through the DCI format 3-0, however, the lowest IRB index for the initial transmission is not included in the frequency domain resource allocation information field; therefore, it is needed to add an information field to inform the sending UE of the lowest IRB index. As an example, assuming that a sub-band of 20 MHz have 5 IRB indexes {0, 1, 2, 3, 4}, that is, L=5, a bit length of log₂(L) may be used; that is, 3 bits may be used to represent it; if the lowest IRB index for the initial transmission is 1, 001 may be used to represent it.

In another possible implementation, X is [log₂(L)], L is a quantity of IRB indexes included in an LBT sub-band, and L is a positive integer, where the frequency domain resource allocation indication domain does not indicate the position of the lowest IRB index for the initial transmission, and the frequency domain resource allocation supports continuous IRB index allocation. As an example, in response to determining that the frequency domain resource allocation indication domain does not indicate the position of the lowest IRB index for the initial transmission and the frequency domain resource allocation supports continuous IRB index allocation, the quantity of bits X of the first part is determined as [log₂(L)], where L is the quantity of IRB indexes included in an LBT sub-band.

For example, it is assumed that the frequency domain resource allocation field in the DCI format 3-0 does not indicate the position of the lowest (i.e., starting) IRB index for the initial transmission, and only supports continuous IRB index allocation (for example, IRB indexes 2, 3 and 4 are continuously occupied, and occupation of IRB indexes 1 and 4 is not supported). In the DCI format 3-0, the frequency domain resource allocation field does not indicate the position of the lowest IRB Index for the initial transmission, and only indicates the quantity of occupied continuous IRBs; for the sending UE, the position of the lowest IRB index for the initial transmission indicated by the information field still needs to be additionally carried in DCI 3-0. In this case, the quantity of bits X of the first part in the DCI format 3-0 is log₂(L), where the X bits represent the length of the occupied continuous IRBs. For example, assuming that L=5, if the starting IRB index is 0, there are 5 possible lengths of 1, 2, 3, 4, and 5; if the starting IRB index is 3, there are 2 possible lengths of 1 (for example, only IRB index 3 is occupied) and 2 (for example, IRB index 3 and 4 are occupied); and therefore, there is at most L possibilities.

As an example, as shown in FIG. 9, assuming that the SCS=15 KHz, the LBT sub-band is 20 MHz, L=5, and there are 50 PRBs, if the IRB index is 0, and the continuous occupancy length is 1 (that is, IRB index 0 is occupied), 001 is used to represent it; if the continuous occupancy length is 2 (that is, IRB indexes 0 and 1 are occupied), 010 is used to represent it; and if the continuous occupancy length is 3 (that is, IRB indexes 0, 1, and 2 are occupied), 011 is used to represent it.

In some embodiments, the downlink control information further includes a lowest IRB index indication domain, and the lowest IRB index indication domain is used to indicate the position of the lowest IRB index for the initial transmission, where the quantity of bits of the lowest IRB index indication domain is log₂(L). That is, the frequency domain resource allocation field in the DCI format 3-0 does not indicate the position of the lowest IRB index for the initial transmission, but only indicates whether the IRB index higher than the occupied lowest IRB index is occupied or not. For a sending UE, since it is also needed to know the position of the lowest IRB index for the initial data transmission, the information field is additionally carried in the DCI format 3-0 for indicating the lowest IRB index for the initial data transmission. For example, the additional information field of the lowest IRB index for the initial transmission (such as, the lowest index of the IRB allocation to initial transmission) additionally carried in the DCI format 3-0 needs [log₂(L)] bits.

It can be understood that according to the design of R16 V2X in the related art, it is needed to inform the sending UE of the lowest IRB index for the initial transmission through the DCI format 3-0, however, the lowest IRB index for the initial transmission is not included in the frequency domain resource allocation information field; therefore, it is needed to add an information field to inform the sending UE of the lowest IRB index. As an example, assuming that a sub-band of 20 MHz have 5 IRB indexes {0, 1, 2, 3, 4}, that is, L=5, a bit length of [log₂(L)] may be used; that is, 3 bits may be used to represent it; if the lowest IRB index for the initial transmission is 1, 001 may be used to represent it.

It should be noted that, in the frequency domain resource allocation information field in the DCI format 3-0, the position of the lowest IRB index for the initial transmission may be indicated. Therefore, there is no need to design an additional information field in the DCI format 3-0 to inform the sending UE of the lowest IRB index for the initial transmission. According to whether the discrete IRB index allocation is supported or not, there may be the following two methods.

In some embodiments, X is L, L is a quantity of IRB indexes included in an LBT sub-band, and L is a positive integer, where the frequency domain resource allocation indication domain indicates the position of the lowest IRB index for the initial transmission, and the frequency domain resource allocation supports discrete IRB index allocation. As an example, in response to determining that the frequency domain resource allocation indication domain indicates the position of the lowest IRB index for the initial transmission, and the frequency domain resource allocation supports discrete IRB index allocation, the quantity X of bits of the first part is determined as L, where L is the quantity of IRB indexes included in an LBT sub-band (i.e., a resource block set, RB set), L is an integer, and L≥0.

For example, assuming that in the frequency domain resource allocation field in the DCI format 3-0, the position of the lowest IRB index for the initial transmission may be indicated and discrete IRB index allocation is supported, a bitmap may be used for indication. At this time, X=L bits, which indicates the position of the starting IRB index and the quantity of occupied IRBs.

In some embodiments, X is

$$[ {log}_{2} ( \frac{L ( L + 1 )}{2} ) ] ,$$

L is a quantity of IRB indexes included in an LBT sub-band, and L is a positive integer, where the frequency domain resource allocation indication domain indicates the position of the lowest IRB index for the initial transmission, and the frequency domain resource allocation supports continuous IRB index allocation. As an example, in response to determining that the frequency domain resource allocation indication domain indicates the position of the lowest IRB index for the initial transmission, and the frequency domain resource allocation supports continuous IRB index allocation, the quantity of bits X of the first part is determined as

$$⌊ {log}_{2} ( \frac{L ( L + 1 )}{2} ) ⌋ ,$$

where L is the quantity of IRB indexes included in an LBT sub-band.

For example, assuming that in the frequency domain resource allocation information field in the DCI format 3-0, the position of the lowest IRB Index for the initial transmission may be indicated, and continuous IRB Index allocation is supported, at this time,

$$X = [ {log}_{2} ( \frac{L ( L + 1 )}{2} ) ] ,$$

which indicates the starting position of the IRB Index and the quantity of occupied continuous IRBs.

It may be understood that a manner for determining the quantity of bits X of the first part in the DCI is provided above, and a manner for determining the quantity of bits Y of the second part in the DCI is provided below.

In the embodiments of the present application, the design idea of R16 NR-U may be continued to be used, and only resource allocation of continuous RB sets is supported. In addition, according to whether supporting the same distribution rule of IRB indexes in different RB sets or not, there may be the following cases.

In some embodiments, Y is

$$[ {log}_{2} ( \frac{K ( K + 1 )}{2} ) ] ,$$

K is the quantity of resource block sets included in the sidelink bandwidth part (BWP), and K is a positive integer, where the frequency domain resource allocation supports resource allocation of continuous resource block sets, and supports the same distribution rule of the IRB indexes in different resource block sets, and supports reservation of a resource for one transmission. As an example, in response to the frequency domain resource allocation supporting resource allocation of continuous resource block sets, supporting the same distribution rule of the IRB indexes in different resource block sets, and supporting reservation of a resource for one transmission, the quantity of bits Y of the second part is determined as

$$[ {log}_{2} ( \frac{K ( K + 1 )}{2} ) ] ,$$

where K is the quantity of resource block sets included in the sidelink bandwidth part (BWP).

For example, assuming that the frequency domain resource allocation supports resource allocation of continuous resource block sets, supports the same distribution rule of IRB indexes in different resource block sets, and supports reservation of a resource for one transmission (i.e., the frequency domain resource allocation field in DCI may not only indicate the frequency domain resource used for the initial transmission, but also indicate the resource reserved for future transmission, for example, may indicate the resource reserved for one transmission), the quantity of bits Y of the second part in the DCI may be determined as

$$[ {log}_{2} ( \frac{K ( K + 1 )}{2} ) ] ,$$

which indicates a quantity of the starting RB set and the continuous RB sets of the resource reserved for one transmission.

In some embodiments, Y is

$$[ {log}_{2} ( \frac{K ( K + 1 ) ( 2 K + 1 )}{6} ) ] ,$$

is the quantity of resource block sets included in the sidelink bandwidth part (BWP), and K is a positive integer, where the frequency domain resource allocation supports resource allocation of continuous resource block sets, and supports the same distribution rule of the IRB indexes in different resource block sets, and supports reservation of resources for two transmissions. As an example, in response to the frequency domain resource allocation supporting resource allocation of continuous resource block sets, and supporting the same distribution rule of the IRB indexes in different resource block sets, and supporting reservation of resources for two transmissions, the quantity of bits Y of the second part is determined as

$$[ {log}_{2} ( \frac{K ( K + 1 ) ( 2 K + 1 )}{6} ) ] ,$$

where K is the quantity of resource block sets included in the sidelink bandwidth part (BWP).

For example, assuming that the frequency domain resource allocation supports resource allocation of continuous resource block sets, and supports the same distribution rule of the IRB indexes in different resource block sets, and supports reservation of resources for two transmissions (i.e., the frequency domain resource allocation field in DCI may not only indicate the frequency domain resources used for the initial transmission, but also indicate the resource reserved for future transmission, for example, may indicate the resource reserved for two transmissions), the quantity of bits Y of the second part in the DCI may be determined as

$$[ {log}_{2} ( \frac{K ( K + 1 ) ( 2 K + 1 )}{6} ) ] ,$$

which indicates a quantity of the starting RB set of the resource reserved for two transmissions and the continuous RB sets of the resource reserved for one transmissions (where the quantity of continuous RB sets in the resources reserved for two transmissions is the same), where K represents the quantity of resource block sets (RB set) included in the sidelink bandwidth part (BWP).

For example, assuming that the BWP includes K RB sets, and K=5, when reservation of a resource for one transmission is supported, Y=4 bits; when Y for resource allocation is 0100, it indicates that when the starting RB set of the allocated resource reserved for one transmission is the first RB set, the quantity of continuous RB sets is 4, and the distribution rules of the IRB indexes in different RB sets are the same. For example, if the IRB index in the first RB set is allocated with IRB index {0, 1, 2}, the IRB indexes in the RB sets 2, 3, and 4 are also allocated with {0, 1, 2}.

In some embodiments, Y is

$$[ {log}_{2} ( \frac{K ( K + 1 )}{2} ) ] ,$$

K is the quantity of resource block sets included in the sidelink bandwidth part (BWP), and K is a positive integer, where the frequency domain resource allocation supports resource allocation of continuous resource block sets, and supports different distribution rules of IRB indexes in different resource block sets, and supports reservation of a resource for one transmission. As an example, in response to the frequency domain resource allocation supporting resource allocation of continuous resource block sets and supporting different distribution rules of IRB indexes in different resource block sets, and supporting reservation of a resource for one transmission, the quantity of bits Y of the second part is determined as

$$[ {log}_{2} ( \frac{K ( K + 1 )}{2} ) ] ,$$

where K is the quantity of resource block sets included in the sidelink bandwidth part (BWP).

For example, assuming that the frequency domain resource allocation supports resource allocation of continuous resource block sets, and supports different distribution rules of IRB indexes in different resource block sets, and supports reservation of a resource for one transmission, the quantity of bits Y of the second part may be determined as

$$[ {log}_{2} ( \frac{K ( K + 1 )}{2} ) ] ,$$

which indicates a quantity of the starting RB set and the continuous RB sets of the resource reserved for one transmission.

In some embodiments, Y is

$$[ {log}_{2} ( \frac{K ( K + 1 ) ( 2 K + 1 )}{6} ) ] ,$$

K is the quantity of resource block sets included in the sidelink bandwidth part (BWP), and K is a positive integer, where the frequency domain resource allocation supports resource allocation of continuous resource block sets, and supports different distribution rules of the IRB indexes in different resource block sets, and supports reservation of resources for two transmissions. As an example, in response to the frequency domain resource allocation supporting resource allocation of continuous resource block sets and supporting different distribution rules of IRB indexes in different resource block sets, and supporting reservation of resources for two transmissions, the quantity of bits Y of the second part is determined as

$$[ {log}_{2} ( \frac{K ( K + 1 ) ( 2 K + 1 )}{6} ) ] ,$$

where K is the quantity of resource block sets included in the sidelink bandwidth part (BWP).

For example, assuming that the frequency domain resource allocation supports resource allocation of continuous resource block sets, and supports different distribution rules of the IRB indexes in different resource block sets, and supports reservation of resources for two transmissions, the quantity of bits Y of the second part may be determined as

$$[ {log}_{2} ( \frac{K ( K + 1 ) ( 2 K + 1 )}{6} ) ] ,$$

which indicates a quantity of the starting RB set of the resource reserved for two transmissions and the continuous RB sets of the resource reserved for one transmission.

In some embodiments, the downlink control information further includes a first offset indication domain, and the first offset indication domain is used to indicate an offset of the TRB index in adjacent resource block sets in the resource for current transmission, or indicate an offset of the IRB index in adjacent resource block sets in the resource reserved for one transmission, or indicate an offset of the IRB index in adjacent resource block sets in the resource reserved for another transmission, where the quantity of bits of the first offset indication domain is log₂ (L), and L is the quantity of IRB indexes included in an LBT sub-band.

In other words, a new information field of IRB index offset S bit is introduced into the DCI, and the information field indicates the offset of the IRB Index in adjacent RB sets in the resource for current transmission or in the resource reserved for one transmission or in the resource reserved for another transmission. Under this offset, the IRB Index is cyclic, and the quantity of bits of the offset S is log₂(L).

As an example, it is assumed that in the resource for current transmission, three RB sets are allocated; in the first RB set, the distribution of the IRB index is {1, 2}; if the offset of the IRB index in the second RB set is one IRB index, the distribution is {3, 4}; and if the offset of the IRB index in the third RB set relative to the IRB index in the second RB set is also one IRB index, the distribution is {4, 0}. Similarly, for the resource reserved for one transmission, three RB sets are allocated; among the three RB sets, in the first RB set, the distribution of the IRB index is {2, 3}; if the offset of the IRB index in the second RB set is one IRB index, the distribution is {4, 0}; and if the offset of the TRB index in the third RB set relative to the IRB index in the second RB set is also one IRB index, the distribution is {0, 1}. Among them, there are five possible offsets {0, 1, 2, 3, 4}; that is, there are L possibilities. Therefore, [log₂(L)] bits are used to represent it.

It should be noted that the present application may not continue to use the design idea of R16 NR-U, and may support resource allocation of discrete RB sets. According to whether supporting the same distribution rule of IRB indexes in different RB sets or not, there may be the following cases.

In some embodiments, Y is K−1+K, where K is the quantity of resource block sets included in the sidelink bandwidth part (BWP), and K is a positive integer. Among them, the frequency domain resource allocation supports resource allocation of discrete resource block sets, and supports the same distribution rule of the IRB indexes in different resource block sets, and supports reservation of a resource for one transmission. As an example, in response to the frequency domain resource allocation supporting resource allocation of discrete resource block sets and supporting the same distribution rule of the IRB indexes in different resource block sets, and supporting reservation of a resource for one transmission, the quantity of bits Y of the second part is determined as K−1+K, where K is the quantity of resource block sets included in the sidelink bandwidth part (BWP).

For example, a bitmap may be used for indication, where each bit represents whether the RB set is occupied or not. Assuming that the frequency domain resource allocation supports resource allocation of discrete resource block sets, supports the same distribution rule of the IRB indexes in different resource block sets, and supports reservation of a resource for one transmission in SCI (Sidelink Control Information), the quantity of bits Y of the second part may be determined as K−1+K, which indicates the RB set occupied by the current transmission (but only indicates whether the RB set higher than the occupied RB set is occupied or not, thus K−1 bits are needed), and meanwhile indicates the starting position of the resource reserved for one transmission and the occupied RB sets, which needs L bits.

In some embodiments, Y is 3K−1, where K is the quantity of resource block sets included in the sidelink bandwidth part (BWP), and K is a positive integer. Among them, the frequency domain resource allocation supports resource allocation of discrete resource block sets, and supports the same distribution rule of the IRB indexes in different resource block sets, and supports reservation of resources for two transmissions. As an example, in response to the frequency domain resource allocation supporting resource allocation of discrete resource block sets and supporting the same distribution rule of the IRB indexes in different resource block sets, and supporting reservation of resources for two transmissions, the quantity of bits Y of the second part is determined as 3K−1, where K is the quantity of resource block sets included in the sidelink bandwidth part (BWP).

For example, a bitmap may be used for indication, where each bit represents whether the RB set is occupied or not. Assuming that the frequency domain resource allocation supports resource allocation of discrete resource block sets and supports the same distribution rule of the IRB indexes in different resource block sets, and supports reservation of resources for two transmissions, the quantity of bits Y of the second part may be determined as 3K−1, which indicates the RB set occupied by the current transmission, but only indicates whether the RB set higher than the occupied RB set is occupied or not (which needs K−1 bits), meanwhile indicates the starting position of the resource reserved for one transmission and the quantity of the occupied RB sets (which needs K bits), as well as the starting position of the resource reserved for another transmission and the quantity of the occupied RB sets (which needs K bits).

As an example, a bitmap may be used for indication, where each bit represents whether the RB set is occupied or not. It is assumed that the frequency domain resource allocation supports resource allocation of discrete resource block sets, and supports the same distribution rule of the TRB indexes in different resource block. For example, reservation of a resource for one transmission in SCI is supported, Y=K−1+K bits; and assuming K=5, Y=9 bits. As shown in FIG. 10, for the bits of 0011 10001, the first 4 bits of 0011 indicate the RB sets occupied by current transmission, and the RB sets with the indexes of 2, 3, and 4 are occupied (since 0011 indicates whether an RB set with a corresponding index of 1, 2, 3, or 4 is occupied or not, and it represents that the indexes of 3 and 4 are occupied and indicates whether the RB set higher than the occupied RB set is occupied or not, it indicates that the RB set with the index of 2 is also occupied), and the last 5 bits of 10001 indicates the RB sets occupied by the resource reserved for one transmission by using a bitmap. For another example, reservation of resources for two transmissions in SCI is supported; as shown in FIG. 11, Y=3K− 1 bits are used; that is, 14 bits (such as, 0011 10001 11100) is used for indication.

In some embodiments, Y is K−1+K, where K is a quantity of resource block sets included in the sidelink bandwidth part (BWP), and K is a positive integer, where the frequency domain resource allocation supports resource allocation of discrete resource block sets, and supports different distribution rules of IRB indexes in different resource block sets, and supports reservation of a resource for one transmission. As an example, in response to the frequency domain resource allocation supporting resource allocation of discrete resource block sets and supporting different distribution rules of IRB indexes in different resource block sets, and supporting reservation of a resource for one transmission, the quantity of bits Y of the second part is determined as K−1+K, where K is the quantity of resource block sets included in the sidelink bandwidth part (BWP).

For example, the bitmap may be used for indication. If different distribution rules of IRB indexes in different resource block sets is supported, and reservation of a resource for one transmission in SCI is supported, the quantity of bits of the second part may be determined as Y=K−1+K.

In some embodiments, Y is 3K−1, where K is the quantity of resource block sets included in the sidelink bandwidth part (BWP), and K is a positive integer. Among them, the frequency domain resource allocation supports resource allocation of discrete resource block sets, and supports different distribution rules of IRB indexes in different resource block sets, and supports reservation of resources for two transmissions. As an example, in response to the frequency domain resource allocation supporting resource allocation of discrete resource block sets and supporting different distribution rules of IRB indexes in different resource block sets, and supporting reservation of resources for two transmissions, the quantity of bits Y of the second part is determined as 3K−1, where K is the quantity of resource block sets included in the sidelink bandwidth part (BWP).

For example, the bitmap may be used for indication. If different distribution rules of IRB indexes in different resource block sets is supported, and reservation of resources for two transmissions in SCI is supported, the quantity of bits of the second part may be determined as Y=3K−1.

In some embodiments, the downlink control information further includes a second offset indication domain, and the second offset indication domain is used to indicate an offset of IRB indexes in adjacent resource block sets in the resource for the current transmission, or indicate an offset of IRB indexes in adjacent resource block sets in the resource reserved for one transmission, or indicate an offset of IRB indexes in adjacent resource block sets in the resource reserved for another transmission, where the quantity of bits of the second offset indication domain is log₂(L), and L is the quantity of IRB indexes included in an LBT sub-band.

As an example, the bitmap may be used for indication. If different distribution rules of the IRB index in different RB sets is supported, and reservation of a resource for one transmission in SCI is supported, the quantity of bits may be determined as Y=N−1+N. If reservation of resources for two transmissions in SCI is supported, the quantity of bits may be determined as Y=3N−1. However, an information field offset is introduced into the DCI, the information field indicates the offset of the IRB index in adjacent RB sets in the resource for the current transmission or in the resource reserved for one transmission or in the resource reserved for another transmission, and the quantity of bits of the offset may be [log₂(L)].

In conclusion, in the embodiments of the present application, the resource indication is performed based on that the IRB is the minimum frequency domain allocation granularity for PSSCH in the SL-U system, where the frequency domain resource allocation information field in the DCI format 3-0 is redefined, the design of an offset of the IRB index and the design of the lowest IRB index for the initial transmission are introduced. Therefore, the OCB requirement may be satisfied on the unlicensed frequency band based on the resource allocation indication in which the IRB is the frequency domain resource allocation granularity, so that each transmission may occupy 80% of the bandwidth of the LBT sub-band, effectively ensuring the resource utilization rate, thus satisfying future potential diversified application scenarios and requirements.

In some embodiments of the present application, on the basis of any one of the foregoing embodiments, the terminal device may further receive configuration information send by the network device, where different values of the configuration information are used to indicate enabling or disabling sending the downlink control information to the terminal device based on that the IRB is the frequency domain resource allocation granularity.

For example, (preset) configuration information may be added, and the terminal device may obtain the configuration information by receiving downlink control signaling (DCI) or radio resource control (RRC) from the base station, or through pre-configuration. In some embodiments, the configuration information may be configured based on a resource pool, or may be configured based on the UE, or may be configured based on a BWP, or may be configured based on a carrier.

In some embodiments, different values of the configuration information represent enabling or disabling the resource allocation manner in which the IRB is the frequency domain resource allocation granularity.

By implementing the embodiments of the present application, the OCB requirement may be satisfied on the unlicensed frequency band through the resource allocation indication based on that the interlaced resource block (IRB) is the frequency domain resource allocation granularity, so that each transmission may occupy 80% of the bandwidth of the LBT sub-band, effectively ensuring the resource utilization rate, thus satisfying future potential diversified application scenarios and requirements.

In the foregoing embodiments provided in the present application, the methods provided in the embodiments of the present application are described respectively from the perspective of the network device and the terminal device. To implement the functions in the method provided in the foregoing embodiments of the present application, the network device and the terminal device may include hardware structures and software modules, to implement the foregoing functions in a form of hardware structures, software modules, or hardware structures plus software modules. A certain function in the foregoing functions may be performed by using hardware structures, software modules, or hardware structures plus software modules.

Referring to FIG. 13, FIG. 13 is a schematic structural diagram of a communication apparatus 130 according to some embodiments of the present application. It should be noted that the communication apparatus 130 in the embodiments of the present application may be applied to a sidelink unlicensed frequency band. The communication apparatus 130 shown in FIG. 13 may include a transceiving module 1302 and a processing module 1301. The transceiving module 1302 may include a transmitting module and/or a receiving module, the transmitting module is configured to implement a transmitting function, and the receiving module is configured to implement a receiving function, and the transceiving module 1302 may implement a transmitting function and/or a receiving function.

The communication apparatus 130 may be a network device, an apparatus in the network device, or an apparatus that can be used and matched with the network device. Alternatively, the communication apparatus 130 may be a terminal device, an apparatus in the terminal device, or an apparatus that can be used and matched with the terminal device.

The communication apparatus 130 is a network device. In the embodiments of the present application, the processing module 1301 is configured to determine a frequency domain resource allocation granularity, where the frequency domain resource allocation granularity is a sub-channel or an interlaced resource block IRB; and the transceiving module 1302 is configured to send downlink control information to a terminal device based on the frequency domain resource allocation granularity, where the downlink control information includes a frequency domain resource allocation indication domain, and the frequency domain resource allocation indication domain is used to indicate a frequency domain resource allocated to the terminal device.

In some embodiments, the frequency domain resource allocation granularity is a sub-channel, where the processing module 1301 is further configured to determine a mapping relationship between the sub-channel and the IRB, and the transceiving module 1302 is configured to send the downlink control information to the terminal device based on the mapping relationship and that the sub-channel is the frequency domain resource allocation granularity.

In some embodiments, the processing module 1301 is specifically configured to determine the mapping relationship between the sub-channel and the IRB as that an IRB index mapped to a sub-channel, where a quantity of IRB indexes and a quantity of sub-channels included in a given listen-before-talk (LBT) sub-band are the same.

In some embodiments, the processing module 1301 is specifically configured to determine the mapping relationship between the sub-channel and the IRB as that each physical resource block (PRB) in a sub-channel is mapped to a specific PRB in an IRB, where a given LBT sub-band includes M sub-channels and N IRBs, M and N are positive integers respectively, and M≠N.

In some embodiments, the frequency domain resource allocation granularity is an IRB; and the transceiving module 1302 is specifically configured to send the downlink control information to the terminal device based on that the IRB is the frequency domain resource allocation granularity, where the frequency domain resource allocation indication domain in the downlink control information is used to indicate a size and/or a position of a frequency domain resource allocated to the terminal device, and a size of and a starting position of a frequency domain resource in a reserved sidelink resource.

In some embodiments, the frequency domain resource allocation indication domain includes a first part, the first part is used to indicate a quantity and/or a position of an IRB index in an unlicensed LBT sub-band occupied by sidelink transmission, the first part includes X bits, and X is a positive integer.

In some embodiments, the frequency domain resource allocation indication domain further includes a second part, the second part is used to indicate a quantity and/or a position of an unlicensed LBT sub-band occupied by sidelink transmission, the second part includes Y bits, and Y is a positive integer.

In some embodiments, the processing module 1301 is specifically configured to determine X based on whether the frequency domain resource allocation indication domain indicates a position of a lowest IRB index for initial transmission and based on a frequency domain resource allocation manner supported by the frequency domain resource allocation in which an IRB is a granularity.

In some embodiments, X is L−1, L is a quantity of TRB indexes included in an LBT sub-band, and L is a positive integer; where the frequency domain resource allocation indication domain does not indicate the position of the lowest IRB index for the initial transmission, and the frequency domain resource allocation supports discrete IRB index allocation.

In some embodiments, X is [log₂(L)], L is a quantity of IRB indexes included in an LBT sub-band, and L is a positive integer; where the frequency domain resource allocation indication domain does not indicate the position of the lowest IRB index for the initial transmission, and the frequency domain resource allocation supports continuous IRB index allocation.

In some embodiments, the downlink control information further includes a lowest IRB index indication domain, and the lowest IRB index indication domain is used to indicate a position of the lowest IRB index for the initial transmission, where a quantity of bits of the lowest IRB index indication domain is log₂(L).

In some embodiments, X is

$$[ {log}_{2} ( \frac{L ( L + 1 )}{2} ) ] ,$$

L is a quantity of IRB indexes included in an LBT sub-band, L is a positive integer, where the frequency domain resource allocation indication domain indicates the position of the lowest IRB index for the initial transmission, and the frequency domain resource allocation supports continuous IRB index allocation.

In some embodiments, Y is

$$[ {log}_{2} ( \frac{K ( K + 1 )}{2} ) ] ,$$

K is a quantity of resource block sets included in a sidelink bandwidth part (BWP), and K is a positive integer; where the frequency domain resource allocation supports resource allocation of continuous resource block sets, and supports same distribution rules of the IRB indexes in different resource block sets, and supports reservation of a resource for one transmission.

In some embodiments, Y is

$$[ {log}_{2} ( \frac{K ( K + 1 ) ( 2 K + 1 )}{6} ) ] ,$$

K is a quantity of resource block sets included in a sidelink bandwidth part (BWP), and K is a positive integer; where the frequency domain resource allocation supports resource allocation of continuous resource block sets, and supports same distribution rules of the IRB indexes in different resource block sets, and supports reservation of resources for two transmissions.

In some embodiments, Y is

$$[ {log}_{2} ( \frac{K ( K + 1 )}{2} ) ] ,$$

K is a quantity of resource block sets included in a sidelink bandwidth part (BWP), and K is a positive integer; where the frequency domain resource allocation supports resource allocation of continuous resource block sets, and supports different distribution rules of IRB indexes in different resource block sets, and supports reservation of a resource for one transmission.

In some embodiments, Y is

$$[ {log}_{2} ( \frac{K ( K + 1 ) ( 2 K + 1 )}{6} ) ] ,$$

K is a quantity of resource block sets included in a sidelink bandwidth part (BWP), and K is a positive integer; where the frequency domain resource allocation supports resource allocation of continuous resource block sets, and supports different distribution rules of IRB indexes in different resource block sets, and supports reservation of resources for two transmissions.

In some embodiments, the downlink control information further includes a first offset indication domain, and the first offset indication domain is used to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission; where a quantity of bits of the first offset indication domain is log₂(L), and L is a quantity of IRB indexes included in an LBT sub-band.

In some embodiments, Y is K−1+K; where K is a quantity of resource block sets included in a sidelink bandwidth part (BWP), and K is a positive integer; where the frequency domain resource allocation supports resource allocation of discrete resource block sets, and supports same distribution rules of IRB indexes in different resource block sets, and supports reservation of a resource for one transmission.

In some embodiments, Y is 3K−1, where K is a quantity of resource block sets included in a sidelink bandwidth part (BWP), and K is a positive integer; where the frequency domain resource allocation supports resource allocation of discrete resource block sets, and supports same distribution rules of IRB indexes in different resource block sets, and supports reservation of resources for two transmissions.

In some embodiments, Y is K−1+K; where K is a quantity of resource block sets included in a sidelink bandwidth part (BWP), and K is a positive integer; where the frequency domain resource allocation supports resource allocation of discrete resource block sets, and supports different distribution rules of IRB indexes in different resource block sets, and supports reservation of a resource for one transmission.

In some embodiments, Y is 3K−1, where K is a quantity of resource block sets included in a sidelink bandwidth part BWP, and K is a positive integer; where the frequency domain resource allocation supports resource allocation of discrete resource block sets, and supports different distribution rules of IRB indexes in different resource block sets, and supports reservation of resources for two transmissions.

In some embodiments, the downlink control information further includes a second offset indication domain, and the second offset indication domain is used to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission; where a quantity of bits of the second offset indication domain is log₂(L), and L is a quantity of IRB indexes included in an LBT sub-band.

In some embodiments, the transceiving module 1302 is further configured to send configuration information to the terminal device, where different values of the configuration information are used to indicate enabling or disabling sending the downlink control information to the terminal device based on that the TRB is the frequency domain resource allocation granularity.

The communication apparatus 130 is a terminal device. In the embodiments of the present application, the processing module 1301 is configured to determine a frequency domain resource allocation granularity, where the frequency domain resource allocation granularity is a sub-channel or an interlaced resource block IRB; and the transceiving module 1302 is configured to receive downlink control information sent by a network device based on the frequency domain resource allocation granularity, where the downlink control information includes a frequency domain resource allocation indication domain, and the frequency domain resource allocation indication domain is used to indicate a frequency domain resource allocated to the terminal device.

In some embodiments, the frequency domain resource allocation granularity is a sub-channel, where the processing module 1301 is configured to determine a mapping relationship between the sub-channel and the IRB, and the transceiving module 1302 is configured to receive the downlink control information sent by the network device based on the mapping relationship and that the sub-channel is the frequency domain resource allocation granularity.

In some embodiments, the processing module 1301 is specifically configured to determine the mapping relationship between the sub-channel and the IRB as that an IRB index is mapped to a sub-channel, where a quantity of IRB indexes and a quantity of sub-channels included in a given listen-before-talk (LBT) sub-band are the same.

In some embodiments, the processing module 1301 is specifically configured to determine the mapping relationship between the sub-channel and the IRB as that each physical resource block (PRB) in a sub-channel is mapped to a specific PRB in an IRB, where a given LBT sub-band includes M sub-channels and N IRBs, M and N are positive integers respectively, and M≠N.

In some embodiments, the frequency domain resource allocation granularity is an IRB; and the transceiving module 1302 is specifically configured to receive the downlink control information sent by the network device based on that the IRB is a frequency domain resource allocation granularity, where the frequency domain resource allocation indication domain in the downlink control information is used to indicate a size and/or a position of a frequency domain resource allocated to the terminal device, and a size of and a starting position of a frequency domain resource in a reserved sidelink resource.

In some embodiments, the frequency domain resource allocation indication domain includes a first part, the first part is used to indicate a quantity and/or a position of an IRB index in an unlicensed LBT sub-band occupied by sidelink transmission, the first part includes X bits, and X is a positive integer.

In some embodiments, the frequency domain resource allocation indication domain further includes a second part, the second part is used to indicate a quantity and/or a position of an unlicensed LBT sub-band occupied by sidelink transmission, the second part includes Y bits, and Y is a positive integer.

In some embodiments, the processing module 1301 is further configured to determine X based on whether the frequency domain resource allocation indication domain indicates a position of a lowest IRB index for initial transmission and a frequency domain resource allocation manner supported by the frequency domain resource allocation in which the IRB is the granularity

In some embodiments, X is L−1, L is a quantity of IRB indexes included in an LBT sub-band, and L is a positive integer; where the frequency domain resource allocation indication domain does not indicate the position of the lowest IRB index for the initial transmission, and the frequency domain resource allocation supports discrete IRB index allocation.

In some embodiments, X is [log₂(L)], L is a quantity of IRB indexes included in an LBT sub-band, and L is a positive integer; where the frequency domain resource allocation indication domain does not indicate the position of the lowest IRB index for the initial transmission, and the frequency domain resource allocation supports continuous IRB index allocation.

In some embodiments, the downlink control information further includes a lowest TRB index indication domain, and the lowest IRB index indication domain is used to indicate the position of the lowest IRB index for the initial transmission, where a quantity of bits of the lowest IRB index indication domain is [log₂(L)].

In some embodiments, X is L, L is a quantity of IRB indexes included in an LBT sub-band, and L is a positive integer; where the frequency domain resource allocation indication domain indicates the position of the lowest IRB index for the initial transmission, and the frequency domain resource allocation supports discrete IRB index allocation.

In some embodiments, X is

$$[ {log}_{2} ( \frac{L ( L + 1 )}{2} ) ] ,$$

L is a quantity of IRB indexes included in an LBT sub-band, and L is a positive integer; where the frequency domain resource allocation indication domain indicates the position of the lowest IRB index for the initial transmission, and the frequency domain resource allocation supports continuous IRB index allocation.

In some embodiments, Y is

$$[ {log}_{2} ( \frac{K ( K + 1 )}{2} ) ] ,$$

K is a quantity of resource block sets included in a sidelink bandwidth part (BWP), and K is a positive integer; where the frequency domain resource allocation supports resource allocation of continuous resource block sets, and supports same distribution rules of the IRB indexes in different resource block sets, and supports reservation of a resource for one transmission.

In some embodiments, Y is

$$[ {log}_{2} ( \frac{K ( K + 1 ) ( 2 K + 1 )}{6} ) ] ,$$

K is a quantity of resource block sets included in a sidelink bandwidth part (BWP), and K is a positive integer; where the frequency domain resource allocation supports resource allocation of continuous resource block sets, and supports same distribution rules of the IRB indexes in different resource block sets, and supports reservation of resources for two transmissions.

In some embodiments, Y is

$$[ {log}_{2} ( \frac{K ( K + 1 )}{2} ) ] ,$$

K is a quantity of resource block sets included in in a sidelink bandwidth part (BWP), and K is a positive integer; where the frequency domain resource allocation supports resource allocation of continuous resource block sets, and supports different distribution rules of IRB indexes in different resource block sets, and supports reservation of a resource for one transmission.

In some embodiments, Y is

$$[ {log}_{2} ( \frac{K ( K + 1 ) ( 2 K + 1 )}{6} ) ] ,$$

K is a quantity of resource block sets included in a sidelink bandwidth part (BWP), and K is a positive integer; where the frequency domain resource allocation supports resource allocation of continuous resource block sets, and supports different distribution rules of IRB indexes in different resource block sets, and supports reservation of resources for two transmissions.

In some embodiments, the downlink control information further includes a first offset indication domain, and the first offset indication domain is used to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission; where a quantity of bits of the first offset indication domain is [log₂ (L)], and L is a quantity of IRB indexes included in an LBT sub-band.

In some embodiments, Y is K−1+K, where K is a quantity of resource block sets included in a sidelink bandwidth part (BWP), and K is a positive integer; where the frequency domain resource allocation supports resource allocation of discrete resource block sets, and supports same distribution rules of IRB indexes in different resource block sets, and supports reservation of a resource for one transmission.

In some embodiments, Y is 3K−1, where K is a quantity of resource block sets included in a sidelink bandwidth part (BWP), and K is a positive integer; where the frequency domain resource allocation supports resource allocation of discrete resource block sets, and supports same distribution rules of the IRB indexes in different resource block sets, and supports reservation of resources for two transmissions.

In some embodiments, Y is K−1+K, where K is a quantity of resource block sets included in a sidelink bandwidth part (BWP), and K is a positive integer; where the frequency domain resource allocation supports resource allocation of discrete resource block sets, and supports different distribution rules of TRB indexes in different resource block sets, and supports reservation of a resource for one transmission.

In some embodiments, Y is 3K−1, where K is a quantity of resource block sets included in a sidelink bandwidth part (BWP), and K is a positive integer; where the frequency domain resource allocation supports resource allocation of discrete resource block sets, and supports different distribution rules of IRB indexes in different resource block sets, and supports reservation of resources for two transmissions.

In some embodiments, the downlink control information further includes a second offset indication domain, and the second offset indication domain is used to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission; where a quantity of bits of the second offset indication domain is [log₂(L)], and L is a quantity of IRB indexes included in an LBT sub-band.

In some embodiments, the transceiving module 1302 is further configured to receive configuration information sent by the network device, where different values of the configuration information are used to indicate enabling or disabling sending downlink control information to the terminal device based on that the IRB is the frequency domain resource allocation granularity.

With regard to the apparatus in the above embodiments, the specific manners in which the various modules perform operations have been described in detail in the embodiments related to the method, which will not be described here.

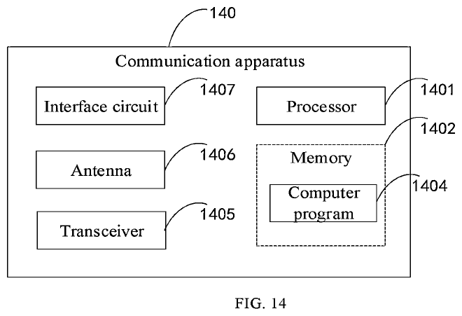

FIG. 14 is a schematic structural diagram of another communication apparatus 140 according to some embodiments of the present application. The communication apparatus 140 may be a network device or a terminal device. The communication apparatus 140 may also be a chip, a chip system, a processor, or the like that supports the network device to implement the foregoing method. The communication apparatus 140 may also be a chip, a chip system, a processor, or the like that supports the terminal device to implement the foregoing method. The apparatus may be configured to implement the method described in the foregoing method embodiments. For details, reference may be made to the descriptions in the foregoing method embodiments.

The communication apparatus 140 may include one or more processors 1401, and the processor 1401 may be a general-purpose processor or a dedicated processor, such as a baseband processor or a central processor. The baseband processor may be configured to process a communication protocol and communication data, and the central processor may be configured to control the communication apparatus (for example, a base station, a baseband chip, a terminal device, a terminal device chip, a DU or a CU), execute a computer program, and process data of the computer program.

In some embodiments, the communication apparatus 140 may further include one or more memories 1402, a computer program 1404 may be stored on a memory 1402, and the processor 1401 executes the computer program 1404 to enable the communication apparatus 140 to perform the method described in the foregoing method embodiments. In some embodiments, the memory 1402 may further store with data. The communication apparatus 140 and the memory 1402 may be separately provided, or may be integrated together.

In some embodiments, the communication apparatus 140 may further include a transceiver 1405 and an antenna 1406. The transceiver 1405 may be referred to as a transceiving unit, a transceiving machine, a transceiving circuit, or the like, and is configured to implement a transceiving function. The transceiver 1405 may include a receiver and a transmitter, the receiver may be referred to as a receiving machine or a receiving circuit, and is configured to implement a receiving function; and the transmitter may be referred to as a transmitting machine or a transmitting circuit, and is configured to implement a transmitting function.

In some embodiments, the communication apparatus 140 may further include one or more interface circuits 1407. The interface circuit 1407 is configured to receive a code instruction and transmit the code instruction to the processor 1401. The processor 1401 runs the code instruction to enable the communication apparatus 140 to perform the method described in the foregoing method embodiments.

The communication apparatus 140 is a network device. The processor 1401 is configured to perform step 201 in FIG. 2, perform step 601 and the step of “determining a mapping relationship between the sub-channel and the IRB” in FIG. 6, and perform step 701 in FIG. 7. The transceiver 1405 is configured to perform step 202 in FIG. 2, perform the step of “sending downlink control information to a terminal device based on the mapping relationship and that the sub-channel is the frequency domain resource allocation granularity” in FIG. 6, and perform step 702 in FIG. 7.

The communication apparatus 140 is a terminal device. The processor 1401 is configured to perform step 1201 in FIG. 12. The transceiver 1405 is configured to perform step 1202 in FIG. 12.

In some embodiments, the processor 1401 may include a transceiver configured to implement a receiving and transmitting function. For example, the transceiver may be a transceiving circuit, an interface, or an interface circuit. The transceiving circuit, the interface, or the interface circuit configured to implement the receiving and transmitting function may be separate, or may be integrated together. The transceiving circuit, the interface, or the interface circuit may be configured for reading and writing of code/data. Alternatively, the transceiving circuit, the interface, or the interface circuit may be configured for transmission or delivery of a signal.

In some embodiments, the processor 1401 may store with a computer program 1403, and the computer program 1403 runs on the processor 1401 to enable the communication apparatus 140 to perform the method described in the foregoing method embodiments. The computer program 1403 may be cured in the processor 1401, and in this case, the processor 1401 may be implemented by hardware.

In some embodiments, the communication apparatus 140 may include a circuit, and the circuit may implement a function of transmitting or receiving or communication in the foregoing method embodiments. The processor and the transceiver described in the present application may be implemented on an integrated circuit (IC), an analog IC, a radio frequency integrated circuit (RFIC), a mixed signal IC, an application specific integrated circuit (ASIC), a printed circuit board (PCB), an electronic device, or the like. The processor and the transceiver may also be fabricated using various IC process technologies, such as complementary metal oxide semiconductor (CMOS), n-type metal oxide semiconductor (NMOS), positive channel metal oxide semiconductor (PMOS), bipolar junction transistor (BJT), bipolar CMOS (BiCOMS), Silicon Germanium (SiGe), Gallium Arsenide (GaAs), etc.

The communication apparatus described in the foregoing embodiments may be a network device or a terminal device (such as, a first terminal device in the foregoing method embodiments); however, the scope of the communication apparatus described in the present disclosure is not limited to this, and the structure of the communication apparatus may not be limited by FIG. 14. The communication apparatus may be an independent device or may be part of a larger device. For example, the communication apparatus may be:
(1) an independent integrated circuit (IC), or a chip, or a chip system or a sub-system;
(2) a set having one or more ICs; in some embodiments, the IC set may also include a storage component for storing data and a computer program;
(3) an ASIC, such as a modem;
(4) a module that may be embedded in other devices;
(5) a receiver, a terminal device, an intelligent terminal device, a cellular phone, a wireless device, a handset, a mobile unit, a vehicle-mounted device, a network device, a cloud device, an artificial intelligence device, or the like;
(6) Others, or the like.

Those skilled in the art may further understand that various illustrative logical blocks and steps listed in the embodiments of the present disclosure may be implemented by electronic hardware, computer software, or a combination of the them. Whether such function is implemented by hardware or software depends upon the particular application and design requirements of the overall system. Those skilled in the art may use functions implemented by various methods for each particular application, but such implementation should not be understood as going beyond the protection scope of the embodiments of the present disclosure.

According to some embodiments of the present application, there is further provided a communication system. The system includes a communication apparatus as a terminal device and a communication apparatus as a network device in the foregoing embodiment in FIG. 13; or the system includes a communication apparatus as a terminal device and a communication apparatus as a network device in the foregoing embodiment in FIG. 14.

According to the present application, there is further provided a readable storage medium with an instruction stored thereon. When the instruction is executed by a computer, the functions of any one of the foregoing method embodiments are implemented.

According to the present application, there is further provided a computer program product. When the computer program product is executed by a computer, the functions of any one of the foregoing method embodiments are implemented.

Embodiments of the present application provide a method for indicating resource allocation, a method for obtaining resource allocation, and an apparatus thereof, which may be applied to an SL-U system. The OCB requirement on an unlicensed frequency band may be satisfied through a resource allocation indication that is based on a sub-channel or an interlaced resource block (IRB) being a frequency domain resource granularity, thus satisfying future potential diversified application scenarios and requirements.

In a first aspect, according to embodiments of the present application, there is provided a method for indicating resource allocation, applied to a sidelink unlicensed frequency band, where the method is performed by a network device, and the method includes:
determining a frequency domain resource allocation granularity, where the frequency domain resource allocation granularity is a sub-channel or an interlaced resource block (IRB); and
sending downlink control information to a terminal device based on the frequency domain resource allocation granularity, where the downlink control information includes a frequency domain resource allocation indication domain, and the frequency domain resource allocation indication domain is configured to indicate a frequency domain resource allocated to the terminal device.

In the technical solution, through the resource allocation indication based on that the sub-channel or the interlaced resource block IRB is the frequency domain resource allocation indication granularity, the OCB requirement can be satisfied on the unlicensed frequency band, effectively ensuring the resource utilization rate, thus satisfying the future potential diversified application scenarios and requirements.

In some embodiments, the frequency domain resource allocation granularity is the sub-channel; and sending the downlink control information to the terminal device based on the frequency domain resource allocation granularity includes:
determining a mapping relationship between the sub-channel and the IRB; and
sending the downlink control information to the terminal device based on the mapping relationship and that the sub-channel is the frequency domain resource allocation granularity.

In some embodiments, determining the mapping relationship between the sub-channel and the IRB includes: determining the mapping relationship between the sub-channel and the IRB as that an IRB index is mapped to a sub-channel, where a quantity of IRB indexes and a quantity of sub-channels included in a given listen-before-talk (LBT) sub-band are the same.

In some embodiments, determining the mapping relationship between the sub-channel and the IRB includes:
determining the mapping relationship between the sub-channel and the IRB as that each physical resource block (PRB) in a sub-channel is mapped to a specific PRB in an IRB, where a given LBT sub-band includes M sub-channels and N IRBs, M and N are positive integers respectively, and M≠N.

In some embodiments, the frequency domain resource allocation granularity is the IRB, and sending the downlink control information to the terminal device based on the frequency domain resource allocation granularity includes: sending the downlink control information to the terminal device based on that the IRB is the frequency domain resource allocation granularity; where the frequency domain resource allocation indication domain in the downlink control information is configured to indicate a size and/or a position of a frequency domain resource allocated to the terminal device, and a size of and a starting position of a frequency domain resource in a reserved sidelink resource.

In some embodiments, the frequency domain resource allocation indication domain includes a first part, the first part is configured to indicate a quantity and/or a position of an IRB index in an unlicensed LBT sub-band occupied by sidelink transmission, the first part includes X bits, and X is a positive integer.

In some embodiments, the frequency domain resource allocation indication domain further includes a second part, the second part is configured to indicate a quantity and/or a position of an unlicensed LBT sub-band occupied by sidelink transmission, the second part includes Y bits, and Y is a positive integer.

In some embodiments, the method further includes: determining X based on whether the frequency domain resource allocation indication domain indicates a position of a lowest IRB index for initial transmission and based on a frequency domain resource allocation manner supported by frequency domain resource allocation in which an IRB is a granularity.

In some embodiments, X is L−1, L is a quantity of IRB indexes included in an LBT sub-band, and L is a positive integer; where the frequency domain resource allocation indication domain does not indicate the position of the lowest IRB index for the initial transmission, and the frequency domain resource allocation supports discrete IRB index allocation.

In some embodiments, X is [log₂(L)], L is a quantity of IRB indexes included in an LBT sub-band, and L is a positive integer; where the frequency domain resource allocation indication domain does not indicate the position of the lowest IRB index for the initial transmission, and the frequency domain resource allocation supports continuous IRB index allocation.

In some embodiments, the downlink control information further includes a lowest IRB index indication domain, and the lowest IRB index indication domain is configured to indicate the position of the lowest IRB index for the initial transmission, where a quantity of bits of the lowest IRB index indication domain is [log₂(L)].

In some embodiments, X is L, L is a quantity of IRB indexes included in an LBT sub-band, and L is a positive integer; where, the frequency domain resource allocation indication domain indicates the position of the lowest IRB index for the initial transmission, and the frequency domain resource allocation supports discrete IRB index allocation.

In some embodiments, X is

$$[ {log}_{2} ( \frac{L ( L + 1 )}{2} ) ] ,$$

L is a quantity of IRB indexes included in an LBT sub-band, and L is a positive integer; where the frequency domain resource allocation indication domain indicates the position of the lowest IRB index for the initial transmission, and the frequency domain resource allocation supports continuous IRB index allocation.

In some embodiments, Y is

$$[ {log}_{2} ( \frac{K ( K + 1 )}{2} ) ] ,$$

K is a quantity of resource block sets included in a sidelink bandwidth part (BWP), and K is a positive integer; where the frequency domain resource allocation supports resource allocation of continuous resource block sets, and supports same distribution rules of IRB indexes in different resource block sets, and supports reservation of a resource for one transmission.

In some embodiments, Y is

$$[ {log}_{2} ( \frac{K ( K + 1 ) ( 2 K + 1 )}{6} ) ] ,$$

K is a quantity of resource block sets included in a sidelink bandwidth part (BWP), and K is a positive integer; where the frequency domain resource allocation supports resource allocation of continuous resource block sets, and supports same distribution rules of IRB indexes in different resource block sets, and supports reservation of resources for two transmissions.

In some embodiments, Y is

$$[ {log}_{2} ( \frac{K ( K + 1 )}{2} ) ] ,$$

K is a quantity of resource block sets included in a sidelink bandwidth part (BWP), and K is a positive integer; where the frequency domain resource allocation supports resource allocation of continuous resource block sets, and supports different distribution rules of IRB indexes in different resource block sets, and supports reservation of a resource for one transmission.

In some embodiments, Y is

$$[ {log}_{2} ( \frac{K ( K + 1 ) ( 2 K + 1 )}{6} ) ] ,$$

K is a quantity of resource block sets included in a sidelink bandwidth part (BWP), and K is a positive integer; where the frequency domain resource allocation supports resource allocation of continuous resource block sets, and supports different distribution rules of IRB indexes in different resource block sets, and supports reservation of resources for two transmissions.

In some embodiments, the downlink control information further includes a first offset indication domain, and the first offset indication domain is configured to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission; where a quantity of bits of the first offset indication domain is log₂ (L), and L is a quantity of IRB indexes included in an LBT sub-band.

In some embodiments, Y is K−1+K; where K is a quantity of resource block sets included in a sidelink bandwidth part (BWP), and K is a positive integer; where the frequency domain resource allocation supports resource allocation of discrete resource block sets, and supports same distribution rules of IRB indexes in different resource block sets, and supports reservation of a resource for one transmission.

In some embodiments, Y is 3K−1, where K is a quantity of resource block sets included in a sidelink bandwidth part (BWP), and K is a positive integer; where the frequency domain resource allocation supports resource allocation of discrete resource block sets, and supports same distribution rules of IRB indexes in different resource block sets, and supports reservation of resources for two transmissions.

In some embodiments, Y is K−1+K; where K is a quantity of resource block sets included in a sidelink bandwidth part (BWP), and K is a positive integer; where the frequency domain resource allocation supports resource allocation of discrete resource block sets, and supports different distribution rules of IRB indexes in different resource block sets, and supports reservation of a resource for one transmission.

In some embodiments, Y is 3K−1, where K is a quantity of resource block sets included in a sidelink bandwidth part (BWP), and K is a positive integer; where the frequency domain resource allocation supports resource allocation of discrete resource block sets, and supports different distribution rules of IRB indexes in different resource block sets, and supports reservation of resources for two transmissions.

In some embodiments, the downlink control information further includes a second offset indication domain, and the second offset indication domain is configured to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission; where a quantity of bits of the second offset indication domain is log₂(L), and L is a quantity of IRB indexes included in an LBT sub-band.

In some embodiments, the method further includes sending configuration information to the terminal device, where different values of the configuration information are configured to indicate enabling or disabling sending the downlink control information to the terminal device based on that the IRB is the frequency domain resource allocation granularity.

In a second aspect, according to embodiments of the present application, there is provided a method for obtaining resource allocation, applied to a sidelink unlicensed frequency band, where the method is performed by a terminal device, and the method includes:
determining a frequency domain resource allocation granularity, where the frequency domain resource allocation granularity is a sub-channel or an interlaced resource block (IRB); and
receiving downlink control information sent by a network device based on the frequency domain resource allocation granularity, where the downlink control information includes a frequency domain resource allocation indication domain, and the frequency domain resource allocation indication domain is configured to indicate a frequency domain resource allocated to the terminal device.

In the technical solution, through the resource allocation indication based on that the sub-channel or the interlaced resource block IRB is the frequency domain resource allocation indication granularity, the OCB requirement can be satisfied on the unlicensed frequency band, effectively ensuring the resource utilization rate, thus satisfying the future potential diversified application scenarios and requirements.

In some embodiments, the frequency domain resource allocation granularity is the sub-channel; and receiving the downlink control information sent by the network device based on the frequency domain resource allocation granularity includes:
determining a mapping relationship between the sub-channel and the IRB; and
receiving the downlink control information sent by the network device based on the mapping relationship and that the sub-channel is the frequency domain resource allocation granularity.

In some embodiments, determining the mapping relationship between the sub-channel and the IRB includes:
determining the mapping relationship between the sub-channel and the IRB as that an IRB index is mapped to a sub-channel, where a quantity of IRB indexes and a quantity of sub-channels included in a given listen-before-talk (LBT) sub-band are the same.

In some embodiments, determining the mapping relationship between the sub-channel and the IRB includes:
determining the mapping relationship between the sub-channel and the IRB as that each physical resource block (PRB) in a sub-channel is mapped to a specific PRB in an IRB, where a given LBT sub-band includes M sub-channels and N IRBs, M and N are positive integers respectively, and M≠N.

In some embodiments, the frequency domain resource allocation granularity is the IRB, and receiving the downlink control information sent by the network device based on the frequency domain resource allocation granularity includes:
sending the downlink control information to the terminal device based on that the TRB is the frequency domain resource allocation granularity;
where the frequency domain resource allocation indication domain in the downlink control information is configured to indicate a size and/or a position of a frequency domain resource allocated to the terminal device, and a size of and a starting position of a frequency domain resource in a reserved sidelink resource.

In some embodiments, the frequency domain resource allocation indication domain includes a first part, the first part is configured to indicate a quantity and/or a position of an IRB index in an unlicensed LBT sub-band occupied by sidelink transmission, the first part includes X bits, and X is a positive integer.

In some embodiments, the frequency domain resource allocation indication domain further includes a second part, the second part is configured to indicate a quantity and/or a position of an unlicensed LBT sub-band occupied by sidelink transmission, the second part includes Y bits, and Y is a positive integer.

In some embodiments, the method further includes: determining X based on whether the frequency domain resource allocation indication domain indicates a position of a lowest IRB index for initial transmission and based on a frequency domain resource allocation manner supported by frequency domain resource allocation in which an IRB is a granularity.

In some embodiments, X is L−1, L is a quantity of TRB indexes included in an LBT sub-band, and L is a positive integer; where the frequency domain resource allocation indication domain does not indicate the position of the lowest IRB index for the initial transmission, and the frequency domain resource allocation supports discrete IRB index allocation.

In some embodiments, X is [log₂(L)], L is a quantity of IRB indexes included in an LBT sub-band, and L is a positive integer; where the frequency domain resource allocation indication domain does not indicate the position of the lowest IRB index for the initial transmission, and the frequency domain resource allocation supports continuous IRB index allocation.

In some embodiments, the downlink control information further includes a lowest TRB index indication domain, and the lowest TRB index indication domain is configured to indicate the position of the lowest IRB index for the initial transmission, where a quantity of bits of the lowest IRB index indication domain is [log₂(L)].

In some embodiments, X is L, L is a quantity of IRB indexes included in an LBT sub-band, and L is a positive integer; where, the frequency domain resource allocation indication domain indicates the position of the lowest IRB index for the initial transmission, and the frequency domain resource allocation supports discrete IRB index allocation.

In some embodiments, X is

$$[ {log}_{2} ( \frac{L ( L + 1 )}{2} ) ] ,$$

L is a quantity of IRB indexes included in an LBT sub-band, and L is a positive integer; where the frequency domain resource allocation indication domain indicates the position of the lowest IRB index for the initial transmission, and the frequency domain resource allocation supports continuous IRB index allocation.

In some embodiments, Y is

$$[ {log}_{2} ( \frac{K ( K + 1 )}{2} ) ] ,$$

K is a quantity of resource block sets included in a sidelink bandwidth part (BWP), and K is a positive integer; where the frequency domain resource allocation supports resource allocation of continuous resource block sets, and supports same distribution rules of IRB indexes in different resource block sets, and supports reservation of a resource for one transmission.

In some embodiments, Y is

$$[ {log}_{2} ( \frac{K ( K + 1 ) ( 2 K + 1 )}{6} ) ] ,$$

K is a quantity of resource block sets included in a sidelink bandwidth part (BWP), and K is a positive integer; where the frequency domain resource allocation supports resource allocation of continuous resource block sets, and supports same distribution rules of IRB indexes in different resource block sets, and supports reservation of resources for two transmissions.

In some embodiments, Y is

$$[ {log}_{2} ( \frac{K ( K + 1 )}{2} ) ] ,$$

K is a quantity of resource block sets included in a sidelink bandwidth part (BWP), and K is a positive integer; where the frequency domain resource allocation supports resource allocation of continuous resource block sets, and supports different distribution rules of IRB indexes in different resource block sets, and supports reservation of a resource for one transmission.

In some embodiments, Y is

$$[ {log}_{2} ( \frac{K ( K + 1 ) ( 2 K + 1 )}{6} ) ] ,$$

K is a quantity of resource block sets included in a sidelink bandwidth part (BWP), and K is a positive integer; where the frequency domain resource allocation supports resource allocation of continuous resource block sets, and supports different distribution rules of IRB indexes in different resource block sets, and supports reservation of resources for two transmissions.

In some embodiments, the downlink control information further includes a first offset indication domain, and the first offset indication domain is configured to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission; where a quantity of bits of the first offset indication domain is log₂ (L), and L is a quantity of TRB indexes included in an LBT sub-band.

In some embodiments, Y is K−1+K; where K is a quantity of resource block sets included in a sidelink bandwidth part (BWP), and K is a positive integer; where the frequency domain resource allocation supports resource allocation of discrete resource block sets, and supports same distribution rules of IRB indexes in different resource block sets, and supports reservation of a resource for one transmission.

In some embodiments, Y is 3K−1, where K is a quantity of resource block sets included in a sidelink bandwidth part (BWP), and K is a positive integer; where the frequency domain resource allocation supports resource allocation of discrete resource block sets, and supports same distribution rules of TRB indexes in different resource block sets, and supports reservation of resources for two transmissions.

In some embodiments, Y is K−1+K; where K is a quantity of resource block sets included in a sidelink bandwidth part (BWP), and K is a positive integer; where the frequency domain resource allocation supports resource allocation of discrete resource block sets, and supports different distribution rules of IRB indexes in different resource block sets, and supports reservation of a resource for one transmission.

In some embodiments, Y is 3K−1, where K is a quantity of resource block sets included in a sidelink bandwidth part (BWP), and K is a positive integer; where the frequency domain resource allocation supports resource allocation of discrete resource block sets, and supports different distribution rules of IRB indexes in different resource block sets, and supports reservation of resources for two transmissions.

In some embodiments, the downlink control information further includes a second offset indication domain, and the second offset indication domain is configured to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission; where a quantity of bits of the second offset indication domain is log₂(L), and L is a quantity of IRB indexes included in an LBT sub-band.

In some embodiments, the method further includes sending configuration information to the terminal device, where different values of the configuration information are configured to indicate enabling or disabling sending the downlink control information to the terminal device based on that the IRB is the frequency domain resource allocation granularity.

In a third aspect, according to embodiments of the present application, there is provided a communication apparatus, where the communication apparatus has some or all functions of the network terminal that implements the method according to the first aspect. For example, functions of the communication apparatus may include functions in some or all embodiments of the present application, or may include functions for separately implementing any embodiment of the present application. The functions may be implemented by hardware, or may be implemented by hardware executing corresponding software. The hardware or the software includes one or more units or modules corresponding to the foregoing functions.

In some embodiments, the structure of the communication apparatus may include a transceiving module and a processing module. The processing module is configured to support the communication apparatus to execute the corresponding functions in the above method. The transceiving module is configured to support communication between communication apparatus and other devices. The communication apparatus may also include a storage module configured to be coupled to the transceiving module and the processing module, which stores necessary computer programs and data for the communication apparatus.

As an example, the processing module may be a processor, the transceiving module may be a transceiver or a communication interface, and the storage module may be a memory.

In some embodiments, the processing module is configured to determine a frequency domain resource allocation granularity, where the frequency domain resource allocation granularity is a sub-channel or an interlaced resource block (IRB); and the transceiving module is configured to send downlink control information to a terminal device based on the frequency domain resource allocation granularity, where the downlink control information includes a frequency domain resource allocation indication domain, and the frequency domain resource allocation indication domain is configured to indicate a frequency domain resource allocated to the terminal device.

In some embodiments, the frequency domain resource allocation granularity is the sub-channel, where the processing module is configured to determine a mapping relationship between the sub-channel and the IRB; and the transceiving module is configured to send the downlink control information to the terminal device based on the mapping relationship and that the sub-channel is the frequency domain resource allocation granularity.

In some embodiments, the processing module is specifically configured to determine the mapping relationship between the sub-channel and the IRB as that an IRB index is mapped to a sub-channel, where a quantity of IRB indexes and a quantity of sub-channels included in a given listen-before-talk (LBT) sub-band are the same.

In some embodiments, the processing module is specifically configured to determine the mapping relationship between the sub-channel and the IRB as that each physical resource block (PRB) in a sub-channel is mapped to a specific PRB in an IRB, where a given LBT sub-band includes M sub-channels and N IRBs, and M and N are positive integers respectively.

In some embodiments, the frequency domain resource allocation granularity is the IRB, where the transceiving module is specifically configured to send the downlink control information to the terminal device based on that the IRB is the frequency domain resource allocation granularity; where the frequency domain resource allocation indication domain in the downlink control information is configured to indicate a size and/or a position of a frequency domain resource allocated to the terminal device, and a size of and a starting position of a frequency domain resource in a reserved sidelink resource.

In some embodiments, the frequency domain resource allocation indication domain includes a first part, the first part is configured to indicate a quantity and/or a position of an IRB index in an unlicensed LBT sub-band occupied by sidelink transmission, the first part includes X bits, and X is a positive integer.

In some embodiments, the frequency domain resource allocation indication domain further includes a second part, the second part is configured to indicate a quantity and/or a position of an unlicensed LBT sub-band occupied by sidelink transmission, the second part includes Y bits, and Y is a positive integer.

In some embodiments, the processing module is further configured to determine X based on whether the frequency domain resource allocation indication domain indicates a position of a lowest IRB index for initial transmission and based on a frequency domain resource allocation manner supported by frequency domain resource allocation in which an IRB is a granularity.

In some embodiments, X is L−1, L is a quantity of IRB indexes included in an LBT sub-band, and L is a positive integer; where the frequency domain resource allocation indication domain does not indicate the position of the lowest IRB index for the initial transmission, and the frequency domain resource allocation supports discrete IRB index allocation.

In some embodiments, X is [log₂(L)], L is a quantity of IRB indexes included in an LBT sub-band, and L is a positive integer; where the frequency domain resource allocation indication domain does not indicate the position of the lowest IRB index for the initial transmission, and the frequency domain resource allocation supports continuous IRB index allocation.

In some embodiments, the downlink control information further includes a lowest IRB index indication domain, and the lowest IRB index indication domain is configured to indicate the position of the lowest IRB index for the initial transmission, where a quantity of bits of the lowest IRB index indication domain is [log₂(L)].

In some embodiments, X is L, L is a quantity of IRB indexes included in an LBT sub-band, and L is a positive integer; where, the frequency domain resource allocation indication domain indicates the position of the lowest IRB index for the initial transmission, and the frequency domain resource allocation supports discrete IRB index allocation.

In some embodiments, X is

$$[ {log}_{2} ( \frac{L ( L + 1 )}{2} ) ] ,$$

L is a quantity of IRB indexes included in an LBT sub-band, and L is a positive integer; where the frequency domain resource allocation indication domain indicates the position of the lowest IRB index for the initial transmission, and the frequency domain resource allocation supports continuous IRB index allocation.

In some embodiments, Y is

$$[ {log}_{2} ( \frac{K ( K + 1 )}{2} ) ] ,$$

K is a quantity of resource block sets included in a sidelink bandwidth part (BWP), and K is a positive integer; where the frequency domain resource allocation supports resource allocation of continuous resource block sets, and supports same distribution rules of IRB indexes in different resource block sets, and supports reservation of a resource for one transmission.

In some embodiments, Y is

$$[ {log}_{2} ( \frac{K ( K + 1 ) ( 2 K + 1 )}{6} ) ] ,$$

K is a quantity of resource block sets included in a sidelink bandwidth part (BWP), and K is a positive integer; where the frequency domain resource allocation supports resource allocation of continuous resource block sets, and supports same distribution rules of IRB indexes in different resource block sets, and supports reservation of resources for two transmissions.

In some embodiments, Y is

$$[ {log}_{2} ( \frac{K ( K + 1 )}{2} ) ] ,$$

K is a quantity of resource block sets included in a sidelink bandwidth part (BWP), and K is a positive integer; where the frequency domain resource allocation supports resource allocation of continuous resource block sets, and supports different distribution rules of IRB indexes in different resource block sets, and supports reservation of a resource for one transmission.

In some embodiments, Y is

$$[ {log}_{2} ( \frac{K ( K + 1 ) ( 2 K + 1 )}{6} ) ] ,$$

K is a quantity of resource block sets included in a sidelink bandwidth part (BWP), and K is a positive integer; where the frequency domain resource allocation supports resource allocation of continuous resource block sets, and supports different distribution rules of IRB indexes in different resource block sets, and supports reservation of resources for two transmissions.

In some embodiments, the downlink control information further includes a first offset indication domain, and the first offset indication domain is configured to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission; where a quantity of bits of the first offset indication domain is [log₂ (L)], and L is a quantity of IRB indexes included in an LBT sub-band.

In some embodiments, Y is K−1+K; where K is a quantity of resource block sets included in a sidelink bandwidth part (BWP), and K is a positive integer; where the frequency domain resource allocation supports resource allocation of discrete resource block sets, and supports same distribution rules of IRB indexes in different resource block sets, and supports reservation of a resource for one transmission.

In some embodiments, Y is 3K−1, where K is a quantity of resource block sets included in a sidelink bandwidth part (BWP), and K is a positive integer; where the frequency domain resource allocation supports resource allocation of discrete resource block sets, and supports same distribution rules of IRB indexes in different resource block sets, and supports reservation of resources for two transmissions.

In some embodiments, Y is K−1+K; where K is a quantity of resource block sets included in a sidelink bandwidth part (BWP), and K is a positive integer; where the frequency domain resource allocation supports resource allocation of discrete resource block sets, and supports different distribution rules of IRB indexes in different resource block sets, and supports reservation of a resource for one transmission.

In some embodiments, Y is 3K−1, where K is a quantity of resource block sets included in a sidelink bandwidth part (BWP), and K is a positive integer; where the frequency domain resource allocation supports resource allocation of discrete resource block sets, and supports different distribution rules of IRB indexes in different resource block sets, and supports reservation of resources for two transmissions.

In some embodiments, the downlink control information further includes a second offset indication domain, and the second offset indication domain is configured to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission; where a quantity of bits of the second offset indication domain is log₂(L), and L is a quantity of IRB indexes included in an LBT sub-band.

In some embodiments, the transceiving module is further configured to send configuration information to the terminal device, where different values of the configuration information are configured to indicate enabling or disabling sending the downlink control information to the terminal device based on that the IRB is the frequency domain resource allocation granularity.

In a fourth aspect, according to embodiments of the present application, there is provided another communication apparatus, where the communication apparatus has some or all functions of the terminal device that implements the method according to the second aspect. For example, functions of the communication apparatus may include functions in some or all embodiments of the present application, or may include functions for separately implementing any embodiment of the present application. The functions may be implemented by hardware, or may be implemented by hardware executing corresponding software. The hardware or the software includes one or more units or modules corresponding to the foregoing functions.

In some embodiments, the structure of the communication apparatus may include a transceiving module and a processing module. The processing module is configured to support the communication apparatus to execute the corresponding functions in the above method. The transceiving module is configured to support communication between communication apparatus and other devices. The communication apparatus may also include a storage module configured to be coupled to the transceiving module and the processing module, which stores necessary computer programs and data for the communication apparatus.

As an example, the processing module may be a processor, the transceiving module may be a transceiver or a communication interface, and the storage module may be a memory.

In some embodiments, the processing module is configured to determine a frequency domain resource allocation granularity, where the frequency domain resource allocation granularity is a sub-channel or an interlaced resource block (IRB); and the transceiving module is configured to receive downlink control information sent by a network device based on the frequency domain resource allocation granularity, where the downlink control information includes a frequency domain resource allocation indication domain, and the frequency domain resource allocation indication domain is configured to indicate a frequency domain resource allocated to a terminal device.

In some embodiments, the frequency domain resource allocation granularity is the sub-channel, where the processing module is configured to determine a mapping relationship between the sub-channel and the IRB; and the transceiving module is configured to receive the downlink control information sent by the network device based on the mapping relationship and that the sub-channel is the frequency domain resource allocation granularity.

In some embodiments, the processing module is specifically configured to determine the mapping relationship between the sub-channel and the IRB as that an IRB index is mapped to a sub-channel, where a quantity of IRB indexes and a quantity of sub-channels included in a given listen-before-talk (LBT) sub-band are the same.

In some embodiments, the processing module is specifically configured to determine the mapping relationship between the sub-channel and the IRB as that each physical resource block (PRB) in a sub-channel is mapped to a specific PRB in an IRB, where a given LBT sub-band includes M sub-channels and N IRBs, and M and N are positive integers respectively.

In some embodiments, the frequency domain resource allocation granularity is the IRB, where the transceiving module is specifically configured to receive the downlink control information sent by the network device based on that the IRB is the frequency domain resource allocation granularity; where the frequency domain resource allocation indication domain in the downlink control information is configured to indicate a size and/or a position of a frequency domain resource allocated to the terminal device, and a size of and a starting position of a frequency domain resource in a reserved sidelink resource.

In some embodiments, the frequency domain resource allocation indication domain includes a first part, the first part is configured to indicate a quantity and/or a position of an IRB index in an unlicensed LBT sub-band occupied by sidelink transmission, the first part includes X bits, and X is a positive integer.

In some embodiments, the frequency domain resource allocation indication domain further includes a second part, the second part is configured to indicate a quantity and/or a position of an unlicensed LBT sub-band occupied by sidelink transmission, the second part includes Y bits, and Y is a positive integer.

In some embodiments, the processing module is further configured to determine X based on whether the frequency domain resource allocation indication domain indicates a position of a lowest IRB index for initial transmission and based on a frequency domain resource allocation manner supported by frequency domain resource allocation in which an IRB is a granularity.

In some embodiments, X is L−1, L is a quantity of IRB indexes included in an LBT sub-band, and L is a positive integer; where the frequency domain resource allocation indication domain does not indicate the position of the lowest IRB index for the initial transmission, and the frequency domain resource allocation supports discrete IRB index allocation.

In some embodiments, X is [log₂(L)], L is a quantity of IRB indexes included in an LBT sub-band, and L is a positive integer; where the frequency domain resource allocation indication domain does not indicate the position of the lowest IRB index for the initial transmission, and the frequency domain resource allocation supports continuous IRB index allocation.

In some embodiments, the downlink control information further includes a lowest TRB index indication domain, and the lowest IRB index indication domain is configured to indicate the position of the lowest IRB index for the initial transmission, where a quantity of bits of the lowest IRB index indication domain is [[log₂(L)].

In some embodiments, X is L, L is a quantity of IRB indexes included in an LBT sub-band, and L is a positive integer; where, the frequency domain resource allocation indication domain indicates the position of the lowest IRB index for the initial transmission, and the frequency domain resource allocation supports discrete IRB index allocation.

In some embodiments, X is

$$[ {log}_{2} ( \frac{L ( L + 1 )}{2} ) ] ,$$

L is a quantity of IRB indexes included in an LBT sub-band, and L is a positive integer; where the frequency domain resource allocation indication domain indicates the position of the lowest IRB index for the initial transmission, and the frequency domain resource allocation supports continuous IRB index allocation.

In some embodiments, Y is

$$[ {log}_{2} ( \frac{K ( K + 1 )}{2} ) ] ,$$

K is a quantity of resource block sets included in a sidelink bandwidth part (BWP), and K is a positive integer; where the frequency domain resource allocation supports resource allocation of continuous resource block sets, and supports same distribution rules of IRB indexes in different resource block sets, and supports reservation of a resource for one transmission.

In some embodiments, Y is

$$[ {log}_{2} ( \frac{K ( K + 1 ) ( 2 K + 1 )}{6} ) ] ,$$

K is a quantity of resource block sets included in a sidelink bandwidth part (BWP), and K is a positive integer; where the frequency domain resource allocation supports resource allocation of continuous resource block sets, and supports same distribution rules of IRB indexes in different resource block sets, and supports reservation of resources for two transmissions.

In some embodiments, Y is

$$[ {log}_{2} ( \frac{K ( K + 1 )}{2} ) ] ,$$

K is a quantity of resource block sets included in a sidelink bandwidth part (BWP), and K is a positive integer; where the frequency domain resource allocation supports resource allocation of continuous resource block sets, and supports different distribution rules of TRB indexes in different resource block sets, and supports reservation of a resource for one transmission.

In some embodiments, Y is

$$[ {log}_{2} ( \frac{K ( K + 1 ) ( 2 K + 1 )}{6} ) ] ,$$

K is a quantity of resource block sets included in a sidelink bandwidth part (BWP), and K is a positive integer; where the frequency domain resource allocation supports resource allocation of continuous resource block sets, and supports different distribution rules of IRB indexes in different resource block sets, and supports reservation of resources for two transmissions.

In some embodiments, the downlink control information further includes a first offset indication domain, and the first offset indication domain is configured to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission; where a quantity of bits of the first offset indication domain is [log₂ (L)], and L is a quantity of IRB indexes included in an LBT sub-band.

In some embodiments, Y is K−1+K; where K is a quantity of resource block sets included in a sidelink bandwidth part (BWP), and K is a positive integer; where the frequency domain resource allocation supports resource allocation of discrete resource block sets, and supports same distribution rules of IRB indexes in different resource block sets, and supports reservation of a resource for one transmission.

In some embodiments, Y is 3K−1, where K is a quantity of resource block sets included in a sidelink bandwidth part (BWP), and K is a positive integer; where the frequency domain resource allocation supports resource allocation of discrete resource block sets, and supports same distribution rules of IRB indexes in different resource block sets, and supports reservation of resources for two transmissions.

In some embodiments, Y is K 1+K; where K is a quantity of resource block sets included in a sidelink bandwidth part (BWP), and K is a positive integer; where the frequency domain resource allocation supports resource allocation of discrete resource block sets, and supports different distribution rules of IRB indexes in different resource block sets, and supports reservation of a resource for one transmission.

In some embodiments, Y is 3K−1, where K is a quantity of resource block sets included in a sidelink bandwidth part (BWP), and K is a positive integer; where the frequency domain resource allocation supports resource allocation of discrete resource block sets, and supports different distribution rules of IRB indexes in different resource block sets, and supports reservation of resources for two transmissions.

In some embodiments, the downlink control information further includes a second offset indication domain, and the second offset indication domain is configured to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission; where a quantity of bits of the second offset indication domain is [log₂(L)], and L is a quantity of IRB indexes included in an LBT sub-band.

In some embodiments, the transceiving module is further configured to receive configuration information sent by the network device, where different values of the configuration information are configured to indicate enabling or disabling sending downlink control information to the terminal device based on that the IRB is the frequency domain resource allocation granularity.

In a fifth aspect, according to embodiments of the present application, there is provided a communication apparatus, where the communication apparatus includes a processor, and when the processor invokes a computer program in a memory, the processor performs the method according to the first aspect.

In a sixth aspect, according to embodiments of the present application, there is provided a communication apparatus, where the communication apparatus includes a processor, and when the processor invokes a computer program in a memory, the processor performs the method according to the second aspect.

In a seventh aspect, according to embodiments of the present application, there is provided a communication apparatus, where the communication apparatus includes a processor and a memory, and the memory stores a computer program; and the processor executes the computer program stored in the memory to enable the communication apparatus to perform the method according to the first aspect.

In an eighth aspect, according to embodiments of the present application, there is provided a communication apparatus, where the communication apparatus includes a processor and a memory, and the memory stores a computer program; and the processor executes the computer program stored in the memory to enable the communication apparatus to perform the method according to the second aspect.

In a ninth aspect, according to embodiments of the present application, there is provided a communication apparatus, where the apparatus includes a processor and an interface circuit, the interface circuit is configured to receive a code instruction and transmit the code instruction to the processor, and the processor is configured to run the code instruction to enable the apparatus to perform the method according to the first aspect.

In a tenth aspect, according to embodiments of the present application, there is provided a communication apparatus, where the apparatus includes a processor and an interface circuit, the interface circuit is configured to receive a code instruction and transmit the code instruction to the processor, and the processor is configured to run the code instruction to enable the apparatus to perform the method according to the second aspect.

In an eleventh aspect, according to embodiments of the present application, there is provided a communication system, where the system includes the communication apparatus according to the third aspect and the communication apparatus according to the fourth aspect, or the system includes the communication apparatus according to the fifth aspect and the communication apparatus according to the sixth aspect, or the system includes the communication apparatus according to the seventh aspect and the communication apparatus according to the eighth aspect, or the system includes the communication apparatus according to the ninth aspect and the communication apparatus according to the tenth aspect.

In a twelfth aspect, according to embodiments of the present application, there is provided a computer-readable storage medium, configured to store an instruction used by the terminal device; and when the instruction is executed, the terminal device is enabled to perform the method according to the first aspect.

In a thirteenth aspect, according to embodiments of the present application, there is provided a readable storage medium, configured to store an instruction used by the network device; and when the instruction is executed, the network device is enabled to perform the method according to the second aspect.

In a fourteenth aspect, according to the present application, there is further provided a computer program product including a computer program, and when the computer program product runs on a computer, the computer is enabled to perform the method according to the first aspect.

In a fifteenth aspect, according to the present application, there is further provided a computer program product including a computer program, and when the computer program product runs on a computer, the computer is enabled to perform the method according to the second aspect.

In a sixteenth aspect, according to the present application, there is provided a computer program; and when the computer program runs on a computer, the computer is enabled to perform the method according to the first aspect.

In a seventeenth aspect, according to the present application, there is provided a computer program; and when the computer program runs on a computer, the computer is enabled to perform the method according to the second aspect.

All or some of the foregoing embodiments may be implemented using software, hardware, firmware, or any combination of them. When software is used to implement the embodiments, all or some of the embodiments may be implemented in a form of a computer program product. The computer program product includes one or more computer programs. When the computer program is loaded and executed on a computer, the procedures or functions according to the embodiments of the present application are all or partially generated. The computer may be a general-purpose computer, a dedicated computer, a computer network, or another programmable apparatus. The computer program may be stored in a computer-readable storage medium, or transmitted from a computer-readable storage medium to another computer-readable storage medium; for example, the computer program may be transmitted from a website, a computer, a server, or a data center to another website, another computer, another server, or another data center in a wired manner (such as, a coaxial cable, an optical fiber, a digital subscriber line (DSL)), or in a wireless manner (such as infrared, wireless, or microwave). The computer-readable storage medium may be any usable medium accessible by a computer, or a data storage device, such as a server or a data center including integration of one or more usable mediums. The usable medium may be a magnetic medium (such as a floppy disk, a hard disk, or a magnetic tape), an optical medium (such as a high-density digital video disk (DVD)), a semiconductor medium (such as a solid state disk (SSD)), or the like.

Those of ordinary skill in the art may understand that various numbers such as first and second involved in the present application are merely for distinguishing for ease of description, and are not intended to limit the scope of the embodiments of the present disclosure, and not to indicate a sequential order either.

“At least one” in the present application may also be described as one or more; and “more than one” may be two, three, four, or more, which is not limited in the present application. In the embodiments of the present disclosure, for a type of technical features, technical features in this type of technical features are distinguished by “first”, “second”, “third”, “A”, “B”, “C”, and “D”, etc. The technical features described by “first”, “second”, “third”, “A”, “B”, “C” and “D” have no sequential order or size order.

The corresponding relationship shown in the various tables in the present application may be configured, or may be predefined. The value of the information in each table is merely an example, and may be configured as other values, which is not limited in the present application. When the corresponding relationships between the information and the various parameters are configured, it is not necessary to configure all corresponding relationships shown in the tables. For example, in the tables in the present application, the corresponding relationships shown in some rows may also not be configured. For another example, appropriate deformation adjustment, such as splitting, merging, or the like, may be performed based on the foregoing tables. Names of the parameters shown by the titles in the foregoing tables may also use other names that may be understood by the communication apparatus, and values or representations of the parameters may also be other values or representations that may be understood by the communication apparatus. When the foregoing tables are implemented, other data structures may be used; for example, an array, a queue, a container, a stack, a linear table, a pointer, a linked list, a tree, a graph, a structure, a class, a heap, or a hash table may be used.

The predefining in the present application may be understood as defining, pre-defining, storing, pre-storing, pre-negotiating, pre-configuration, curing, or pre-firing.

Those of ordinary skill in the art may be aware that, the units and algorithm steps of the various examples described in combination with the embodiments disclosed in the context, may be implemented by electronic hardware or a combination of computer software with electronic hardware. Whether the functions are performed by hardware or software depends on particular applications and design constraint conditions of the technical solutions. Those skilled in the art may use different methods to implement the described functions for each particular application, however, such implementation should not be considered as going beyond the scope of the present application.

It may be clearly understood by those skilled in the art that, for the purpose of convenient and brief description, for the detailed working process of the foregoing system, apparatus and unit, reference may be made to the corresponding process in the foregoing method embodiments, and details are not described here again.

The foregoing descriptions are merely specific implementations of the present application. However, the protection scope of the present application is not limited to this. Any changes or substitutions that may be easily conceived of by those skilled familiar with the art should be covered within the technical scope of the present application. Therefore, the protection scope of the present application shall be subject to the protection scope of the claims.

1. A method for indicating resource allocation, applied to a sidelink-unlicensed frequency band, wherein the method is performed by a network device, and the method comprises:
determining a frequency domain resource allocation granularity, wherein the frequency domain resource allocation granularity is a sub-channel or an interlaced resource block (IRB); and
sending downlink control information to a terminal device based on the frequency domain resource allocation granularity, wherein the downlink control information comprises a frequency domain resource allocation indication domain configured to indicate a frequency domain resource allocated to the terminal device.

2. The method according to claim 1, wherein the frequency domain resource allocation granularity is the sub-channel, and sending the downlink control information to the terminal device based on the frequency domain resource allocation granularity comprises:
determining a mapping relationship between the sub-channel and the IRB; and
sending the downlink control information to the terminal device based on the mapping relationship and the sub-channel.

3. The method according to claim 2, wherein determining the mapping relationship between the sub-channel and the IRB comprises at least one of:
determining the mapping relationship between the sub-channel and the IRB as that an IRB index is mapped to a sub-channel, wherein a quantity of IRB indexes and a quantity of sub-channels comprised in a given listen-before-talk (LBT) sub-band are the same; or
determining the mapping relationship between the sub-channel and the IRB as that each physical resource block (PRB) in a sub-channel is mapped to a specific PRB in an IRB, wherein a given LBT sub-band comprises M sub-channels and N IRBs, M and N being positive integers, respectively.

4. (canceled)

5. The method according to claim 1, wherein the frequency domain resource allocation granularity is the IRB, and sending the downlink control information to the terminal device based on the frequency domain resource allocation granularity comprises:
sending the downlink control information to the terminal device based on that the IRB is the frequency domain resource allocation granularity,
wherein the frequency domain resource allocation indication domain in the downlink control information is configured to indicate at least one of a size or a position of a frequency domain resource allocated to the terminal device, and to indicate a size of and a starting position of a frequency domain resource in a reserved sidelink resource.

6. The method according to claim 5, wherein the frequency domain resource allocation indication domain comprises at least one of:
a first part, wherein the first part is configured to indicate at least one of a quantity or a position of an IRB index in an unlicensed LBT sub-band occupied by sidelink transmission, the first part comprises X bits, and X is a positive integer; or
a second part, wherein the second part is configured to indicate at least one of a quantity or a position of an unlicensed LBT sub-band occupied by sidelink transmission, the second part comprises Y bits, and Y is a positive integer.

7. (canceled)

8. The method according to claim 6, further comprising:
determining X based on whether the frequency domain resource allocation indication domain indicates a position of a lowest IRB index for initial transmission and based on a frequency domain resource allocation manner supported by frequency domain resource allocation in which an IRB is a granularity.

9. The method according to claim 8, wherein L is a quantity of IRB indexes comprised in an LBT sub-band and is a positive integer, and X is determined according to at least one of following manners that:
X is L−1, wherein the frequency domain resource allocation indication domain does not indicate the position of the lowest IRB index for the initial transmission, and the frequency domain resource allocation supports discrete IRB index allocation;
X is log₂(L) wherein the frequency domain resource allocation indication domain does not indicate the position of the lowest IRB index for the initial transmission, and the frequency domain resource allocation supports continuous IRB index allocation;
X is L, wherein the frequency domain resource allocation indication domain indicates the position of the lowest IRB index for the initial transmission, and the frequency domain resource allocation supports discrete IRB index allocation; or
X is
$${log}_{2} ( \frac{L ( L + 1 )}{2} ) ,$$
wherein the frequency domain resource allocation indication domain indicates the position of the lowest IRB index for the initial transmission, and the frequency domain resource allocation supports continuous IRB index allocation.

10. The method according to claim 9, wherein the downlink control information further comprises a lowest IRB index indication domain configured to indicate the position of the lowest IRB index for the initial transmission, and wherein a quantity of bits of the lowest IRB index indication domain is log₂(L).

11. (canceled)

12. The method according to claim 6, wherein K is a quantity of resource block sets comprised in a sidelink bandwidth part (BWP) and is a positive integer, and Y is determined according to at least one of following manners that:
Y is
$${log}_{2} ( \frac{K ( K + 1 )}{2} )$$
wherein the frequency domain resource allocation supports resource allocation of continuous resource block sets, and supports same distribution rules of IRB indexes in different resource block sets, and supports reservation of a resource for one transmission;
Y is
$${log}_{2} ( \frac{K ( K + 1 ) ( 2 K + 1 )}{6} )$$
wherein the frequency domain resource allocation supports resource allocation of continuous resource block sets, and supports same distribution rules of IRB indexes in different resource block sets, and supports reservation of resources for two transmissions;
Y is
$${log}_{2} ( \frac{K ( K + 1 )}{2} ) .$$
wherein the frequency domain resource allocation supports resource allocation of continuous resource block sets, and supports different distribution rules of IRB indexes in different resource block sets, and supports reservation of a resource for one transmission;
Y is
$${log}_{2} ( \frac{K ( K + 1 ) ( 2 K + 1 )}{6} ) ,$$
wherein the frequency domain resource allocation supports resource allocation of continuous resource block sets, and supports different distribution rules of IRB indexes in different resource block sets, and supports reservation of resources for two transmissions;
Y is K−1+K, wherein the frequency domain resource allocation supports resource allocation of discrete resource block sets, and supports same distribution rules of IRB indexes in different resource block sets, and supports reservation of a resource for one transmission; or
Y is 3K−1, wherein the frequency domain resource allocation supports resource allocation of discrete resource block sets, and supports same distribution rules of IRB indexes in different resource block sets, and supports reservation of resources for two transmissions;
Y is K−1+K, wherein the frequency domain resource allocation supports resource allocation of discrete resource block sets, and supports different distribution rules of IRB indexes in different resource block sets, and supports reservation of a resource for one transmission; or
Y is 3K−1, wherein the frequency domain resource allocation supports resource allocation of discrete resource block sets, and supports different distribution rules of IRB indexes in different resource block sets, and supports reservation of resources for two transmissions.

13. (canceled)

14. The method according to claim 12, wherein the downlink control information further comprises a first offset indication domain configured to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission, wherein a quantity of bits of the first offset indication domain is log₂ (L), and L is a quantity of IRB indexes comprised in an LBT sub-band.

15-16. (canceled)

17. The method according to claim 12, wherein the downlink control information further comprises a second offset indication domain configured to indicate an offset of IRB indexes in adjacent resource block sets in a resource for current transmission, or indicate an offset of IRB indexes in adjacent resource block sets in a resource reserved for one transmission, or indicate an offset of IRB indexes in adjacent resource block sets in a resource reserved for another transmission, wherein a quantity of bits of the second offset indication domain is log₂(L), and L is a quantity of IRB indexes comprised in an LBT sub-band.

18. The method according to claim 5, further comprising:
sending configuration information to the terminal device, wherein different values of the configuration information are configured to indicate enabling or disabling sending the downlink control information to the terminal device based on that the IRB is the frequency domain resource allocation granularity.

19. A method for obtaining resource allocation, applied to a sidelink unlicensed frequency band, wherein the method is performed by a terminal device, and the method comprises:
determining a frequency domain resource allocation granularity, wherein the frequency domain resource allocation granularity is a sub-channel or an interlaced resource block (IRB); and
receiving downlink control information sent by a network device based on the frequency domain resource allocation granularity, wherein the downlink control information comprises a frequency domain resource allocation indication domain configured to indicate a frequency domain resource allocated to the terminal device.

20. The method according to claim 19, wherein the frequency domain resource allocation granularity is the sub-channel, and receiving the downlink control information sent by the network device based on the frequency domain resource allocation granularity comprises:
determining a mapping relationship between the sub-channel and the IRB; and
receiving the downlink control information sent by the network device based on the mapping relationship and the sub-channel.

21-22. (canceled)

23. The method according to claim 19, wherein the frequency domain resource allocation granularity is the IRB, and receiving the downlink control information sent by the network device based on the frequency domain resource allocation granularity comprises:
receiving the downlink control information sent by the network device based on that the IRB is the frequency domain resource allocation granularity,
wherein the frequency domain resource allocation indication domain in the downlink control information is configured to indicate at least one of a size or a position of a frequency domain resource allocated to the terminal device, and to indicate a size of and a starting position of a frequency domain resource in a reserved sidelink resource.

24-35. (canceled)

36. The method according to claim 23, further comprising:
receiving configuration information sent by the network device, wherein different values of the configuration information are configured to indicate enabling or disabling sending downlink control information to the terminal device based on that the IRB is the frequency domain resource allocation granularity.

37-38. (canceled)

39. A communication apparatus, comprising a processor and a memory, wherein the memory stores a computer program, and the processor executes the computer program stored in the memory to enable the communication apparatus to perform a method comprising:
determining a frequency domain resource allocation granularity, wherein the frequency domain resource allocation granularity is a sub-channel or an interlaced resource block (IRB) and
sending downlink control information to a terminal device based on the frequency domain resource allocation granularity, wherein the downlink control information comprises a frequency domain resource allocation indication domain configured to indicate a frequency domain resource allocated to the terminal device.

40. A communication apparatus, comprising a processor and a memory, wherein the memory stores a computer program, and the processor executes the computer program stored in the memory to enable the communication apparatus to perform the method according to claim 19.

41. A non-transitory computer-readable storage medium, configured to store an instruction, wherein, when the instruction is executed, the method according to claim 1 is implemented.

42. A non-transitory computer-readable storage medium, configured to store an instruction, wherein, when the instruction is executed, the method according to claim 19 is implemented.
